(19) United States
(12) Patent Application Publication
(10) Pub. No.: US 2025/0362399 A1
(43) Pub. Date: Nov. 27, 2025

(54) IN-VEHICLE SENSOR INSTALLATION STRUCTURE AND ACOUSTIC SENSOR DEVICE

(71) Applicant: DENSO CORPORATION, Kariya-city (JP)

(72) Inventors: YU KOYAMA, Nisshin-city (JP); YOSHIHIRO HIROHASHI, Kariya-city (JP); YUKIMASA TAMATSU, Kariya-city (JP); RYOMA NIIHARA, Kariya-city (JP)

(21) Appl. No.: 19/292,540

(22) Filed: Aug. 6, 2025

Related U.S. Application Data
(63) Continuation of application No. PCT/JP2024/000933, filed on Jan. 16, 2024.

(30) Foreign Application Priority Data
Feb. 9, 2023 (JP) 2023-018454

(51) Int. Cl. G01S 7/521; H04R 1/02; H04R 17/02

(52) U.S. Cl. CPC G01S 7/521; H04R 1/028; H04R 17/02; H04R 2410/07; H04R 2499/13

(57) ABSTRACT

An in-vehicle sensor installation structure includes an external structure part and an acoustic sensor device. The external structure part is in a plate shape, and has: an outer surface that is exposed to exterior of a vehicle and faces rear of the vehicle; and an inner surface positioned on a rear side of the outer surface. The acoustic sensor device includes a sensor housing and a sound detection sensor unit. The sensor housing is secured against the inner surface of the external structure part. The sound detection sensor unit is accommodated in the sensor housing and has an exterior sound collection surface. The exterior sound collection surface detects a sound from outside of the vehicle and a vibration within the external structure part, and faces the external structure part.

### CROSS REFERENCE TO RELATED APPLICATIONS

The present application is a continuation application of International Patent Application No. PCT/JP2024/000933 filed on Jan. 16, 2024, which designated the U.S. and claims the benefit of priority from Japanese Patent Application No. 2023-018454 filed on Feb. 9, 2023. The entire disclosures of all of the above applications are incorporated herein by reference.

### TECHNICAL FIELD

The present disclosure related to an in-vehicle sensor installation structure and an acoustic sensor device.

### BACKGROUND

A vehicle upper structure may have a peripheral information detector that may be located on an upper part of a vehicle.

### SUMMARY

The present disclosure describes an in-vehicle sensor installation structure that may include an external structure part and an acoustic sensor device.

### BRIEF DESCRIPTION OF DRAWINGS

FIG. 1 is a diagram for explaining locations where an in-vehicle sensor installation structure according to the present disclosure can be applied.

FIG. 2 is a diagram showing a basic configuration of an acoustic sensor device using a MEMS microphone.

FIG. 3 is a diagram showing an assembly process of the acoustic sensor device.

FIG. 4 is a diagram showing a configuration of the acoustic sensor device according to a first embodiment.

FIG. 5 is a plan view of a sensor housing accommodating two MEMS microphones.

FIG. 6 is a bottom view of the sensor housing accommodating two MEMS microphones.

FIG. 7 is a diagram showing an electrical configuration of an acoustic sensor device including two MEMS microphones and an ECU.

FIG. 8 is a diagram showing a basic configuration of an acoustic sensor device using a piezoelectric sensor.

FIG. 9 is a diagram for explaining a detailed configuration of the piezoelectric sensor.

FIG. 10 is a diagram showing an assembly process of the acoustic sensor device.

FIG. 11 is a diagram showing a configuration of an acoustic sensor device according to a second embodiment.

FIG. 12 is a bottom view of a sensor housing accommodating four piezoelectric sensors.

FIG. 13 is a diagram showing an electrical configuration of the acoustic sensor device including four piezoelectric sensors and an ECU.

FIG. 14 is a diagram showing a configuration of an acoustic sensor device according to a third embodiment.

FIG. 15 is a diagram showing the configuration of the acoustic sensor device according to a modified example of the third embodiment.

FIG. 16 is a diagram showing a configuration of an acoustic sensor device according to the fourth embodiment.

FIG. 17 is a diagram showing a configuration of an acoustic sensor device according to a fifth embodiment.

FIG. 18 is a diagram showing an attachment process of the acoustic sensor device according to a sixth embodiment.

FIG. 19 is a diagram showing a configuration of the acoustic sensor device according to the sixth embodiment.

FIG. 20 is a diagram showing the configuration of the acoustic sensor device according to a modified example of the sixth embodiment.

FIG. 21 is a diagram showing a configuration of an acoustic sensor device according to a seventh embodiment.

FIG. 22 is a diagram showing a configuration of an acoustic sensor device according to an eighth embodiment.

FIG. 23 is a diagram showing an in-vehicle sensor installation structure according to a ninth embodiment.

FIG. 24 is a diagram showing a configuration of an acoustic sensor device according to a tenth embodiment.

FIG. 25 is a diagram showing the configuration of the acoustic sensor device according to a modified example of the tenth embodiment.

FIG. 26 is a diagram showing an in-vehicle sensor installation structure according to an eleventh embodiment.

FIG. 27 is a sectional view taken along line XXVII-XXVII of FIG. 26.

FIG. 28 is a diagram showing an in-vehicle sensor installation structure and an acoustic sensor device according to Modification Example 1.

FIG. 29 is a diagram showing an in-vehicle sensor installation structure and an acoustic sensor device according to Modification Example 2.

FIG. 30 is a diagram showing an in-vehicle sensor installation structure and an acoustic sensor device according to Modification Example 3.

FIG. 31 is a diagram showing an in-vehicle sensor installation structure and an acoustic sensor device according to Modification Example 4.

FIG. 32 is a diagram showing an in-vehicle sensor installation structure and an acoustic sensor device according to Modification Example 5.

FIG. 33 is a diagram showing an in-vehicle sensor installation structure and an acoustic sensor device according to Modification Example 6.

FIG. 34 is a diagram showing a piezoelectric sensor of an acoustic sensor device according to Modification Example 7.

FIG. 35 is a diagram showing a piezoelectric sensor of an acoustic sensor device according to Modification Example 8.

FIG. 36 is a diagram showing a piezoelectric sensor of an acoustic sensor device according to Modification Example 9.

FIG. 37 is a diagram showing an in-vehicle sensor installation structure and an acoustic sensor device according to Modification Example 10.

FIG. 38 is a diagram showing an in-vehicle sensor installation structure and an acoustic sensor device according to Modification Example 11.

FIG. 39 is a diagram showing an in-vehicle sensor installation structure and an acoustic sensor device according to Modification Example 12.

FIG. 40 is a diagram showing the arrangement of an acoustic sensor device in an in-vehicle sensor installation structure according to Modification Example 13.

### DETAILED DESCRIPTION

In a related field, a vehicle upper structure may be provided such that a peripheral information detection sensor is mounted on an upper part of a vehicle. In this vehicle upper structure, a roof panel has a section that may cover the peripheral information detection sensor and faces a detection unit of the peripheral information sensor. The section is made of a material that allows a detection medium to pass through. In the related field, radio waves, light, and ultrasonic waves are exemplified as detection media used by the peripheral information detection sensor.

The inventors in the present disclosure have conceived of installing an acoustic sensor device in a vehicle to detect sounds and vibrations arriving from outside of the vehicle.

According to an aspect of the disclosure, an in-vehicle sensor installation structure includes an external structure part and an acoustic sensor device. The external structure part has a rear outer surface and a rear inner surface. The external structure part has a plate shape. The rear outer surface is exposed to an exterior of a vehicle and faces rear of the vehicle, and the rear inner surface is positioned on a rear side of the rear outer surface. The acoustic sensor device includes a sensor housing and a sound detection sensor unit. The sensor housing is secured against the rear inner surface. The sound detection sensor unit is accommodated in the sensor housing. The sound detection sensor unit has an exterior sound collection surface that faces the external structure part and detects a sound from outside of the vehicle and a vibration within the external structure part.

In this aspect, the acoustic sensor device is adapted to the external structure part of the vehicle in such a manner that the external sound collection surface faces the rear of the vehicle. Therefore, the acoustic sensor device can effectively collect sounds arriving from the rear of the vehicle and vibrations within the external structure part. Accordingly, it becomes possible to achieve an installation configuration that is suitable for an acoustic sensor device that detects sound and vibrations.

According to another aspect of the disclosure, an in-vehicle sensor installation structure includes an external structure part, an acoustic sensor device and an adhesive layer. The external structure part has a plate shape, and includes an upper outer surface and an upper inner surface. The upper outer surface is exposed to an exterior of a vehicle and faces top of the vehicle, the upper inner surface is positioned on a rear side of the rear outer surface. The acoustic sensor device includes a sensor housing and a sound detection sensor unit. The sensor housing is secured against the upper inner surface. The sound detection sensor unit is accommodated in the sensor housing. The sound detection sensor unit has an exterior sound collection surface that faces the external structure part and detects a sound from outside of the vehicle and a vibration within the external structure part. The adhesive layer is in a form of a thin film that secures the acoustic sensor device against the upper inner surface.

According to yet another aspect of the disclosure, an in-vehicle sensor installation structure includes an external structure part, an acoustic sensor device and a retaining member. The external structure part has a plate shape, and includes an upper outer surface and an upper inner surface. The upper outer surface is exposed to an exterior of a vehicle and faces top of the vehicle, the upper inner surface is positioned on a rear side of the rear outer surface. The acoustic sensor device includes a sensor housing and a sound detection sensor unit. The sensor housing is secured against the upper inner surface. The sound detection sensor unit is accommodated in the sensor housing. The sound detection sensor unit has an exterior sound collection surface that faces the external structure part and detects a sound from outside of the vehicle and a vibration within the external structure part. The retaining member secures the acoustic sensor device against the upper inner surface.

In these aspects, the acoustic sensor device is attached to the external structure part by having the attachment surface provided on the sensor housing held on the upper inner surface by a thin film-like adhesive layer or a retaining member. Therefore, the acoustic sensor device can be easily and reliably attached to external structure parts of various configurations. Accordingly, it becomes possible to achieve an attachment suitable for the acoustic sensor device that detects sound and vibrations.

Additionally, according to another aspect of the disclosure, an acoustic sensor device is secured against an external structure part of a vehicle. The external structure part has a plate shape. The acoustic sensor device includes a sound detection sensor unit and a sensor housing. The sound detection sensor unit has a sound collection surface that detects a sound and a vibration within the external structure part. The sensor housing is secured against an inner surface of the external structure part by an adhesive layer. The sensor housing accommodates the sound detection sensor unit such that the sound collection surface is along the inner surface.

In this aspect, since the sensor housing is provided with an attachment surface, the acoustic sensor device can be held on the inner surface of the external structure part over a wide area using double-sided tape or adhesive material. Accordingly, the acoustic sensor device can be easily and reliably attached to external structure parts of various configurations. Thus, it becomes possible to achieve an attachment suitable for an acoustic sensor device that detects sound and vibrations.

The following describes several embodiments with reference to the drawings. In addition, corresponding components in each embodiment may be denoted by the same reference numerals, and redundant explanations may be omitted. In cases where only a portion of the configuration is described in each embodiment, the other portions of the configuration can be applied by referring to the configurations described in other previously explained embodiments. Moreover, not only the combinations of configurations explicitly described in each embodiment, but also the configurations of multiple embodiments can be partially combined with each other, as long as there is no hindrance to the combination.

### [Attachment Position of Acoustic Sensor Device]

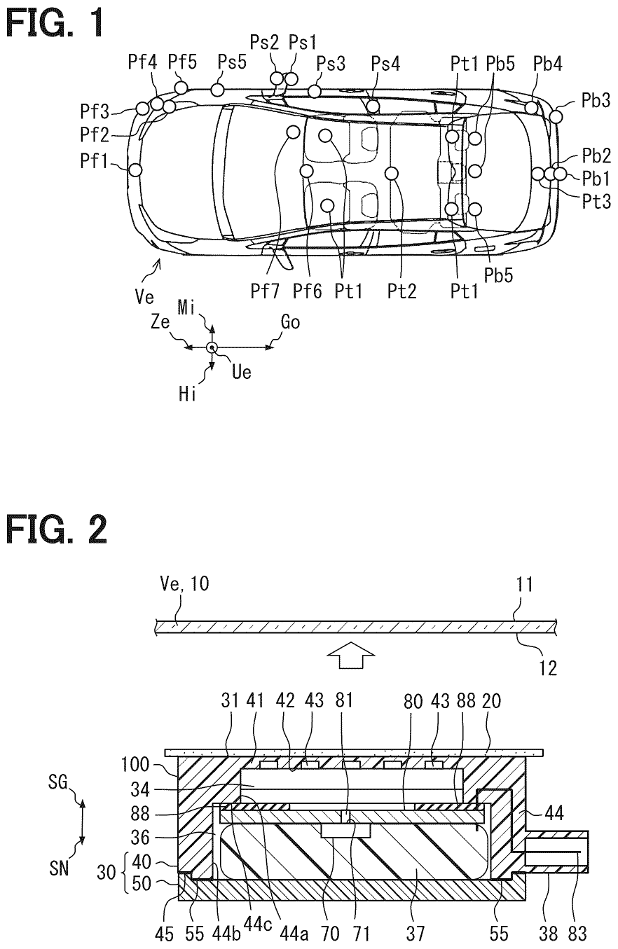

An in-vehicle sensor installation structure according to the present disclosure can be applied to various locations in a vehicle Ve shown in FIGS. 1 and 2. The in-vehicle sensor installation structure can be provided on the front, sides, rear, and top surfaces of the vehicle. As a result, an acoustic sensor device 100 can be installed inside various locations exposed to the exterior of the vehicle Ve.

The vehicle Ve includes an external structure part 10 having a shape that combines smooth curved surfaces and flat surfaces to enhance design and aerodynamic characteristics. Additionally, for the purpose of weight reduction, the majority of the structure is made of thin, plate-like components. These plate-like portions vibrate when they receive sound arriving from the outside. Additionally, vibrations transmitted from the road surface and vibrations generated when the vehicle collides are conveyed within the external structure part 10, causing the plate-like portions to vibrate. By measuring these vibrations and the sound re-radiated due to the vibrations with the acoustic sensor device 100, it is possible to indirectly detect the sound arriving from outside and the vibrations of the vehicle.

The acoustic sensor device 100 is attached to the external structure part 10 of the vehicle Ve, which has a plate-like form. The external structure part 10 at the front of the vehicle includes, for example, a front emblem Pf1, a headlamp Pf2, a front fog lamp Pf3, a bumper corner Pf4, a bumper side Pf5, a front camera Pf6, a windshield Pf7, and a millimeter-wave radar. The acoustic sensor device 100 installed on an external structure part 10 at the front of the vehicle adopts a position where the external sound collection surface 71 is oriented towards the front Ze of the vehicle Ve, primarily detecting sounds arriving from the front Ze outside the vehicle Ve.

The external structure part 10 on the side of the vehicle includes, for example, a side mirror Ps1, a side mirror cover Ps2, a door Ps3, various pillars (such as B-pillars Ps4), a side fender Ps5, a fender camera, a fender lidar, a side step, and a tire house. The acoustic sensor device 100 installed on the side mirror Ps1 adopts a position where the external sound collection surface 71 is oriented towards the rear Go of the vehicle Ve, detecting sounds arriving from the rear Go outside the vehicle Ve. The acoustic sensor device 100 installed on the side mirror cover Ps2 adopts a position where the external sound collection surface 71 is oriented towards the front Ze of the vehicle Ve, detecting sounds arriving from the front Ze outside the vehicle Ve. The acoustic sensor device 100 installed on the other external structure part 10 on the side of the vehicle adopts a position where the external sound collection surface 71 is oriented towards the right Mi or left Hi of the vehicle Ve, primarily detecting sounds arriving from the side outside the vehicle Ve.

The external structure part 10 on the rear of the vehicle include, for example, a backup camera Pb1, a rear peeking window Pb2, the rear surface of a back door or hatch, a reflector Pb3, a tail lamp module Pb4, the edge of the rear glass Pb5, and an ADAS rear camera module. The rear bumper and rear emblem may also be considered as external structure part 10 on the rear of the vehicle. The acoustic sensor device 100 installed on the external structure part 10 at the rear of the vehicle adopts a position where the external sound collection surface 71 is oriented towards the rear Go of the vehicle Ve, primarily detecting sounds arriving from the rear Go outside the vehicle Ve.

The external structure part 10 on the upper surface of the vehicle include, for example, the four corners Pt1 or the center Pt2 of the roof panel (ceiling), the upper surface Pt3 of the trunk lid, the sunroof, roof rails, rear spoiler, and roof end spoiler. The housing of an ADAS sensor (such as a camera or LiDAR module) mounted on the roof panel may also be considered as the external structure part 10 on the upper surface of the vehicle. The acoustic sensor device 100 installed on the external structure part 10 on the upper surface of the vehicle adopts a position where the external sound collection surface 71 is oriented upwards Ue of the vehicle Ve, detecting sounds arriving from all directions (front, rear, left, and right) around the vehicle Ve.

Here, the longitudinal direction (front and rear) and the lateral direction (left and right) in the present disclosure are defined based on a vehicle Ve that is stationary on a horizontal plane. Specifically, the longitudinal direction (forward Ze and rearward Go) is defined along the longitudinal axis (direction of travel) of the vehicle Ve. Additionally, the lateral direction (right Mi and left Hi) is defined along the width of the vehicle Ve. Furthermore, the vertical direction (upwards Ue) is defined along the perpendicular direction to the horizontal plane that specifies the longitudinal and lateral directions. For the sake of simplicity in the description, the notation of the symbols indicating each direction may be omitted as appropriate in the following explanation.

### First Embodiment

An in-vehicle sensor installation structure according to a first embodiment of the present disclosure is applied to an exterior structural part 10 at the rear of the vehicle. As shown in FIG. 2, the in-vehicle sensor installation structure has, for example, an exterior structural part 10, an adhesive layer 20, and an acoustic sensor device 100.

The exterior structural part 10 has a rear outer surface 11 that is exposed to the outside of the vehicle Ve in a posture facing the rear Go of the vehicle Ve. The exterior structural part 10 is, for example, the aforementioned rear peep window Pb2 (see FIG. 1), and is formed of a plate-like glass. The exterior structural part 10 may be flat or may be slightly curved. In the exterior structural part 10, a rear inner surface 12 of the rear outer surface 11, to which the adhesive layer 20 is attached, is smooth. In the configuration where the acoustic sensor device 100 is attached to the edge Pb5 of the rear peep window Pb2 or the rear glass, the rear inner surface 12 is defined by the area where the light-blocking black ceramic layer is formed.

The adhesive layer 20 is formed using double-sided tape or an adhesive material. The adhesive layer 20 secures the attachment surface 31 of the acoustic sensor device 100 to the rear inner surface 12 by joining each surface respectively to the rear inner surface 12 and the acoustic sensor device 100. The adhesive layer 20 is formed as a thin film that is thinner than the exterior structural part 10, and it transmits the sound that reaches the exterior structural part 10 toward the acoustic sensor device 100. In the configuration where double-sided tape is used as the adhesive layer 20, one adhesive surface of the adhesive layer 20 is first affixed to the attachment surface 31 of the acoustic sensor device 100. Then, the other adhesive surface of the adhesive layer 20 is affixed to the rear inner surface 12. Through these processes, the acoustic sensor device 100 is fixed to the exterior structural part 10.

### [Basic Configuration of the Acoustic Sensor Device]

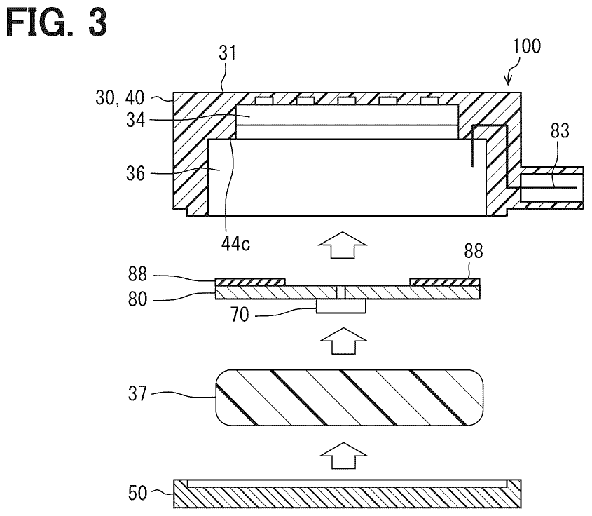

As shown in FIG. 2 and FIG. 3, the acoustic sensor device 100 includes a sensor housing 30, a MEMS microphone 70, and a circuit board 80. The sensor housing 30 houses the MEMS microphone 70 and the circuit board 80. The sensor housing 30 is provided with an attachment surface 31, a sealed space 34, an interior space 36, and a connector part 38.

The attachment surface 31 is a flat mounting surface provided on the sensor housing 30. The attachment surface 31 is attached to the rear inner surface 12 of the external structure part 10 via the adhesive layer 20. As a result, the sensor housing 30 is held on the rear inner surface 12.

The sealed space 34 and the interior space 36 are accommodating spaces partitioned within the sensor housing 30. The accommodating space of the sensor housing 30 is divided into the sealed space 34 and the interior space 36 by the circuit board 80. The sealed space 34 is formed on the attachment surface 31 side (hereinafter referred to as the exterior side SG) relative to the circuit board 80. The interior space 36 is formed on the opposite side of the sealed space 34 with the circuit board 80 in between (hereinafter referred to as the interior side SN).

The sealed space 34 is partitioned between the attachment surface 31 and an exterior sound collection surface 71 of the MEMS microphone 70 (to be described later). The sealed space 34 is a hollow space filled with air or an inert gas. The attachment surface 31 side within the sealed space 34 is designed to increase its area within a range that is smaller than half the wavelength of the highest frequency sound being measured. This allows for sensitive sound collection of the sound re-radiated due to the vibration of the external structure part 10. Additionally, the height of the sealed space 34, that is, the distance from the inner bottom wall surface 42 (to be described later) to the front surface of the circuit board 80, is made shorter than the wavelength of the highest frequency sound being measured. As a result, the sealed space 34 functions as a sound collection space for gathering sound.

A soundproof filler 37 is housed in the interior space 36. The soundproof filler 37 is housed in the sensor housing 30 behind the circuit board 80 and is positioned on the opposite side of the sealed space 34, with the circuit board 80 in between (see FIG. 3). The soundproof filler 37 fills substantially the entire interior space 36, forming a soundproof structure on the interior side SN of the circuit board 80. In other words, the soundproof filler 37 exhibits both sound absorption and soundproof effects against the sound arriving at the sensor housing 30 from the interior side SN. In addition, the soundproof filler 37 suppresses the vibrations of the MEMS microphone 70 and the circuit board 80. Furthermore, the soundproof filler 37 prevents the entry of air containing water vapor into the interior space 36, thereby suppressing the occurrence of condensation caused by temperature changes between day and night.

The soundproof filler 37 is formed from a soft elastic material such as urethane or silicone, or from a porous soft elastic material such as sponge. A sound-absorbing material such as nonwoven fabric or cotton may also be used as the soundproof filler 37. The soundproof filler 37 may be pre-formed and then placed in the interior space 36, or it may be formed by filling the interior space 36 with urethane, silicone, or their foams and then curing them. When filling the interior space 36 with a curable filler such as urethane or silicone, the circuit board 80 functions as a seal to prevent the entry of the uncured soundproof filler 37 or its additives into the sealed space 34. The soundproof filler 37 may also be referred to as soundproof material.

The connector part 38 is provided in a tubular shape on the side surface of the sensor housing 30. Inside the connector part 38, the plug portion of the wire harness is inserted. By connecting the plug portion to the connector part 38, the detection signal of the MEMS microphone 70 can be output to external components (such as the ECU 90 described later) through the wire harness.

The sensor housing 30 includes components such as a main housing body 40 and a rear cover 50. The sensor housing 30 as a whole has a flat rectangular or cylindrical shape. The main housing body 40 and the rear cover 50 are primarily made of resin material. The main housing body 40 has an attachment bottom wall 41 and a peripheral wall 44.

The attachment bottom wall 41 is the bottom wall of the sensor housing 30 that forms the attachment surface 31. On the opposite side of the attachment surface 31 of the attachment bottom wall 41, an inner bottom wall surface 42 facing the sealed space 34 is formed. The inner bottom wall surface 42 is provided with a porous structure consisting of numerous (multiple) recesses 43 (see also FIG. 6). The recesses 43 are arranged on the inner bottom wall surface 42 with spaces between them. The recesses 43 partially reduce the wall thickness of the attachment bottom wall 41. This structure allows for an improvement in sound transmission while preventing a decrease in the strength of the attachment bottom wall 41.

The peripheral wall 44 is erected from the periphery of the attachment bottom wall 41 towards the vehicle interior side SN. The peripheral wall 44 surrounds the MEMS microphone 70 and the circuit board 80 entirely around their perimeters. The wall thickness of the peripheral wall 44 is made sufficiently thicker than the wall thicknesses of the external structure part 10 and the attachment bottom wall 41. With this configuration, the peripheral wall 44 prevents the intrusion of sound (vibration) from the sides. The connector part 38 is provided on one of the outer wall surfaces of the peripheral wall 44. The peripheral wall 44 includes an upper peripheral wall portion 44a that defines the sealed space 34 and a lower peripheral wall portion 44b that defines the interior space 36. An annular stepped portion 44c facing the vehicle interior side SN is formed between the upper peripheral wall portion 44a and the lower peripheral wall portion 44b (see also FIG. 6).

The rear cover 50 has an overall rectangular plate shape. The rear cover 50, together with the main housing body 40, forms the sealed space 34 and the interior space 36 as a sealed, liquid-tight accommodation space. The thickness of the rear cover 50 and the soundproof filler 37 is greater than the wall thickness of the attachment bottom wall 41. As a result, the sound absorption rate of the rear sound absorption structure formed by the rear cover 50 and the soundproof filler 37 is greater than that of the external structure part 10 and the attachment bottom wall 41. The rear cover 50 is fixed to the top surface of the peripheral wall 44 by an adhesive portion 55 while compressing the soundproof filler 37 between it and the rear surface of the circuit board 80 (see FIG. 3). The adhesive portion 55 is formed, for example, by an adhesive material or the like. The rear cover 50 may also be joined to the main housing body 40 by welding. By soundproofing the sound arriving from the lateral and rear directions with the peripheral wall 44, the rear cover 50, and the soundproof filler 37, the acoustic sensor device 100 mounted on the external structure part 10 can be made to have directivity toward the rear external surface 11 direction. Furthermore, if the soundproof filler 37 alone is sufficient for soundproofing and can adequately seal the device, the rear cover 50 is not necessary.

The MEMS (Micro Electro Mechanical Systems) microphone 70 is a microphone element that converts sound (air vibrations) into electrical signals. The MEMS microphone 70 functions as a condenser microphone, outputting the change in capacitance generated by the vibration of a thin diaphragm (membrane) due to sound pressure as an electrical signal (hereinafter referred to as a detection signal). The MEMS microphone 70 is mounted on the rear side of the circuit board 80. The MEMS microphone 70 introduces sound through a sound hole provided on the sound collection surface (hereinafter referred to as the exterior sound collection surface 71), with a diaphragm placed within the internal space. The exterior sound collection surface 71 is housed in the sensor housing 30 in a position oriented towards the external structure part 10. As a result, the MEMS microphone 70 effectively detects the sound that arrives at the external structure part 10 from outside the vehicle Ve and is transmitted to the sealed space 34. It should be noted that, instead of the MEMS microphone 70, an electret condenser microphone or other similar devices can be employed as the sound detection sensor.

The circuit board 80 is made of materials such as glass epoxy and generally has a rectangular plate-like shape. The circuit board 80 is housed in the sensor housing 30 in a position aligned with the attachment bottom wall 41 and is fixed to the stepped section 44c of the peripheral wall 44 via a board fixing material 88 (see FIG. 3). The board fixing material 88 is formed in a thin film shape using rubber gaskets, double-sided tape, adhesive materials, or similar substances. The circuit board 80, together with the sensor housing 30, partitions the sealed space 34 and the interior space 36. Furthermore, the circuit board 80 utilizes the board fixing material 88 as a seal to define a sealed space 34. For convenience, of the two sides of the circuit board 80, the side facing the sealed space 34 is referred to as the front side, while the opposite side is referred to as the back side.

The MEMS microphone 70 is mounted on the back side of the circuit board 80. An acoustic hole 81 is formed in the portion of the circuit board 80 that lies between the exterior sound collection surface 71 and the sealed space 34. The acoustic hole 81 is a through-hole that penetrates the circuit board 80 in the thickness direction. The acoustic hole 81 allows the vibration of the air in the sealed space 34 to be transmitted to the exterior sound collection surface 71.

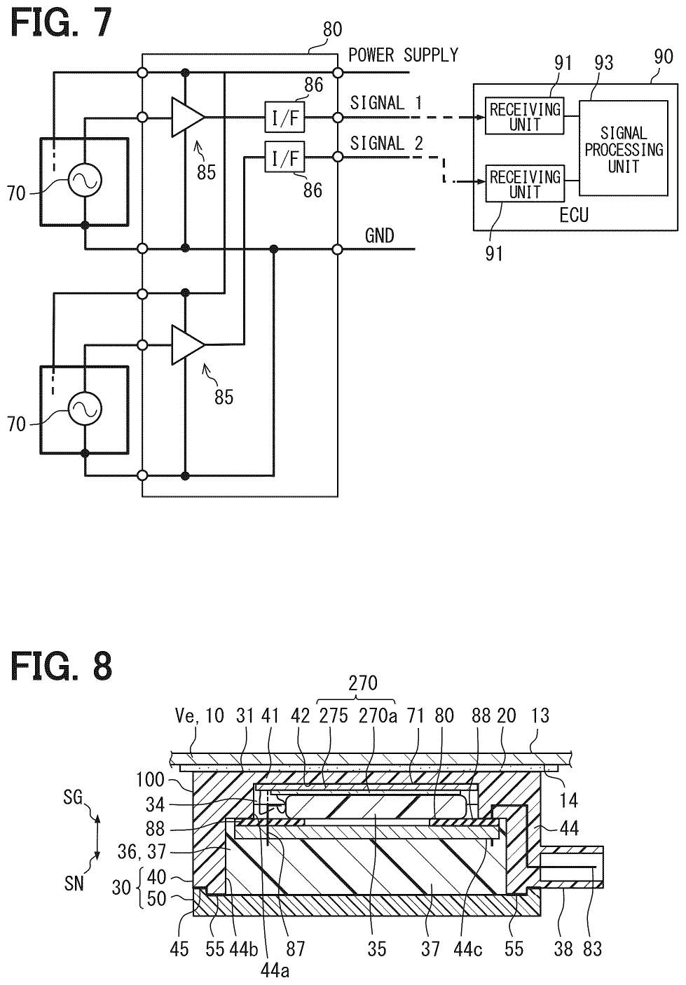

The circuit board 80 is provided with an amplifier circuit unit 85 and a communication interface 86 (see FIG. 7). The amplifier circuit unit 85 is electrically connected to the MEMS microphone 70 and amplifies the detection signal output by the MEMS microphone 70. The communication interface 86 outputs the detection signal amplified by the amplifier circuit unit 85.

The circuit board 80 is electrically connected to multiple connector insert pins 83 when housed in the sensor housing 30. The connector insert pins 83 are made of a metallic material. The intermediate portion of the connector insert pins 83 is embedded in the peripheral wall 44 of the housing body 40. One end of the connector insert pins 83 is exposed inside the connector part 38. The connector insert pins 83 transmit detection signals and other outputs from the communication interface 86 to the wiring inside the plug section connected to the connector part 38.

### [Acoustic Sensor Device According to First Embodiment]

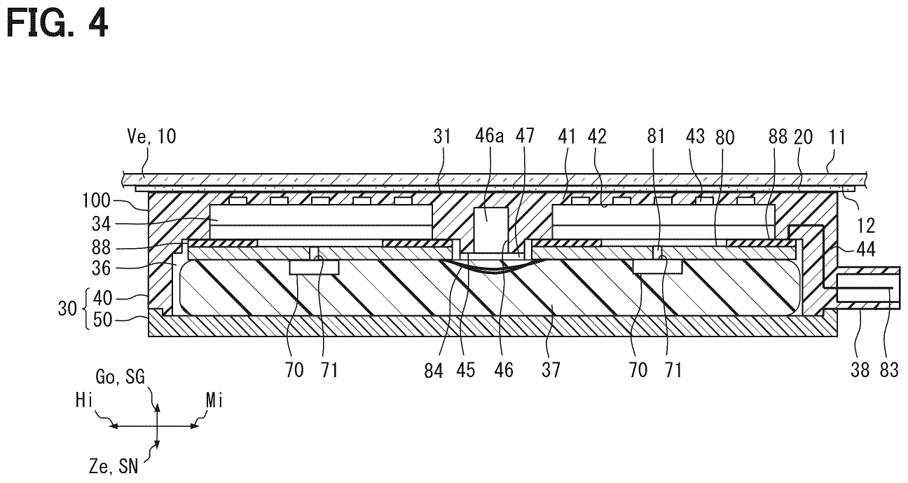

The acoustic sensor device 100 according to the first embodiment shown in FIGS. 4 to 6 is configured by combining multiple (two) acoustic sensor devices 100 of the basic configuration shown in FIG. 2. The acoustic sensor device 100 includes two circuit boards 80 on which the MEMS microphones 70 are mounted. That is, the acoustic sensor device 100 has two MEMS microphones 70. By mounting the acoustic sensor device 100 on the rear inner surface 12, the two MEMS microphones 70 are positioned in a horizontal alignment on the vehicle Ve, with the external sound collection surfaces 71 facing the rear Go of the vehicle Ve. In the first embodiment, each MEMS microphone 70 is arranged in alignment along the lateral direction of the vehicle Ve, spaced apart by a distance of several centimeters (for example, 5 cm). The two circuit boards 80 are electrically connected by a board connection line 84. The detection signals from the two MEMS microphones 70 are output from the connector insert pins 83 that are exposed at the connector part 38.

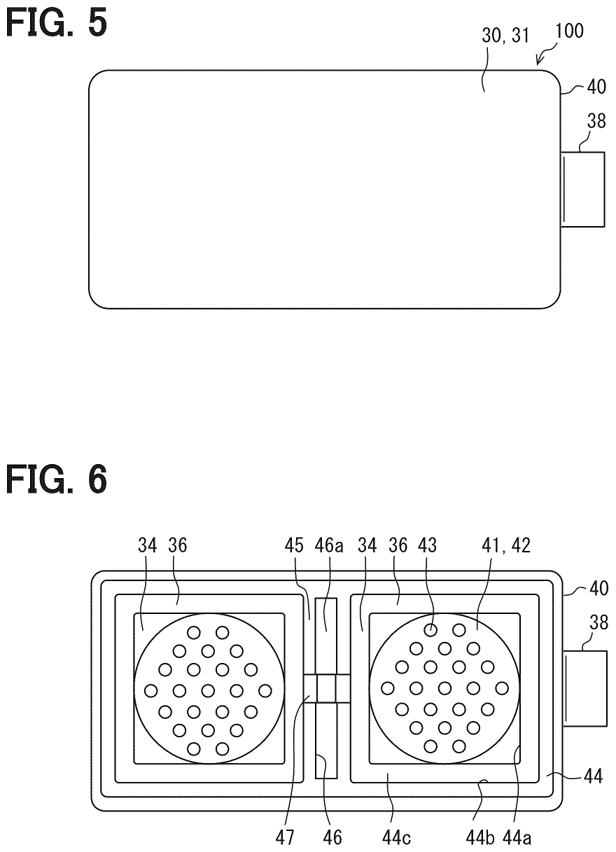

The attachment surface 31 formed on the sensor housing 30 has a rectangular shape with the longitudinal direction extending horizontally (see FIG. 5). Inside the sensor housing 30, two independent sealed spaces 34 and two interior spaces 36 connected by a space connection part 47 are partitioned. The soundproof filler 37 housed in the interior spaces 36 may be integrally formed or divided into two parts.

The sensor housing 30 is provided with a shielding wall 45 and a shielding groove 46. The shielding wall 45 is erected from the attachment bottom wall 41 toward the interior side SN, partitioning the two sealed spaces 34. The shielding wall 45 extends along the short side direction of the sensor housing 30 so as to separate the two MEMS microphones 70 and the sealed spaces 34. The shielding wall 45 suppresses the transmission of sound (vibrations) from one of the two sealed spaces 34 to the other. The shielding groove 46 is recessed from the top surface of the shielding wall 45 toward the exterior side SG. The shielding groove 46 forms a hollow soundproof space 46a, or a soundproof space filled with a soundproof filler, in the shielding wall 45, separating the two MEMS microphones 70 and the sealed spaces 34. By forming the soundproof space 46a in the shielding wall 45, the transmission of sound from one of the two sealed spaces 34 to the other is further suppressed. For the soundproof filler here, silicone, urethane, or their foams are used. By connecting the interior space 36 with the shielding groove 46, it becomes possible to fill both the interior space 36 and the shielding groove 46 with the soundproof filler in a single filling operation. If sufficient soundproofing can be achieved with the shielding wall 45, the shielding groove 46 may not be necessary.

### [Electrical Configuration of Acoustic Sensor Device]

Next, the details of the electrical configuration of the acoustic sensor device 100 and the ECU 90 will be explained with reference to FIG. 7.

Each circuit board 80 of the acoustic sensor device 100 is provided with the aforementioned amplifier circuit unit 85 and communication interface 86. The amplifier circuit unit 85 and communication interface 86 are each provided for every MEMS microphone 70. Each communication interface 86 individually outputs the detection signal of each MEMS microphone 70 to the ECU 90.

An ECU 90 is a computing device adapted to the vehicle Ve. The ECU 90 is electrically connected to the acoustic sensor device 100 via a wiring harness or the like, and functions as a signal processing device that processes the detection signals output by the acoustic sensor device 100. The ECU 90 includes a signal receiving unit 91 and a signal processing unit 93.

The signal receiving unit 91 is provided in the ECU 90 in a number corresponding to the number of MEMS microphones 70, in other words, the number of detection signal channels input to the ECU 90. In the configuration where two detection signals are input to the ECU 90, at least two signal receiving units 91 are provided in the ECU 90. Detection signals (see signals 1 and 2 in FIG. 7) output from multiple MEMS microphones 70 are input to each signal receiving unit 91. The signal receiving unit 91 includes a Fast Fourier Transform (FFT) function and provides the signal processing unit 93 with the Fourier-transformed signal of the detection signals.

The signal processing unit 93 performs signal processing based on the signal difference of multiple detection signals. The signal processing unit 93 calculates differences in physical quantities of the provided detection signals, such as phase differences, time differences, sound pressure differences, and amplitude products. The ECU 90 uses the calculated differences in physical quantities to compute information related to the relative position of the sound source detected by each MEMS microphone 70, such as the direction of arrival of sound and vibrations. As an example, the signal receiving unit 91 estimates the direction of an emergency vehicle (such as an ambulance) approaching the vehicle Ve from the sound of the siren of the emergency vehicle.

### Summary of the First Embodiment

In the first embodiment described so far, the exterior sound collection surface 71 is oriented to face the rear of the vehicle Ve, and the acoustic sensor device 100 is mounted on the external structure part 10 of the vehicle Ve. Therefore, the acoustic sensor device 100 can effectively collect sound arriving from the rear of the vehicle Ve. Accordingly, it becomes possible to achieve a mounting configuration suitable for the acoustic sensor device 100 to detect sound and vibrations.

Specifically, the acoustic sensor device 100 is affixed to the rear inner surface 12 of the external structure part 10 that faces the rear Go of the vehicle Ve. With such an in-vehicle sensor installation structure, it becomes difficult for rain to hit the sensor during driving, thereby reducing rain impact noise. Therefore, even during rainfall, surrounding sounds and vibrations can be effectively detected. Furthermore, it enables sensitive detection of emergency vehicles approaching from the rear Go of the vehicle Ve.

Additionally, the acoustic sensor device 100 is no longer exposed to the exterior of the vehicle Ve. As a result, the design aesthetics of the vehicle Ve are less likely to be compromised. Moreover, improved waterproofing and protection against damage from chipping due to flying stones and the like are achieved. Furthermore, wind noise is less likely to occur in the vicinity of the acoustic sensor device 100. Additionally, issues such as clogging from wax and water ingress from high-pressure car washes are also prevented.

Additionally, the MEMS microphone 70 is housed within the sensor housing 30 and is protected by the sensor housing 30. According to this configuration, the peripheral wall 44 of the sensor housing 30 blocks the input of vibrations from directions other than the rear G. As a result, the acoustic sensor device 100 can more effectively capture sound arriving from the rear G.

Furthermore, being protected by the sensor housing 30, the MEMS microphone 70 can be prevented from being damaged during transportation and storage. Additionally, it becomes possible to improve waterproof and dustproof capabilities, as well as to suppress the occurrence of condensation. In addition, if characteristic and sealing inspections are performed at the sensor assembly factory before shipment, it becomes less likely for moisture, foreign matter, and chemicals to enter the sealed interior of the sensor housing 30. Furthermore, by filling the sealed space 34 with an inert gas such as nitrogen, it is possible to suppress the deterioration and characteristic fluctuations of the MEMS microphone caused by moisture and oxygen in the air. Additionally, a desiccant or deoxidizer may be placed inside the sealed space 34 to remove moisture and oxygen contained in the air.

Additionally, in the first embodiment, the sensor housing 30 is provided with the flat attachment surface 31. The attachment surface 31 is held on the rear inner surface 12 by the thin adhesive layer 20. Thus, with an in-vehicle sensor installation structure that uses the adhesive layer 20 such as double-sided tape or adhesive material, processing of the external structure part 10 becomes unnecessary. In other words, the installation of the acoustic sensor device 100 becomes easier, and it is unnecessary to provide the external structure part 10 with complex structures such as screw holes and locking claws. Furthermore, as long as the external structure part 10 is exposed to the outside air, the acoustic sensor device 100 can be mounted anywhere. Additionally, the repair (replacement) of the acoustic sensor device 100 in the market also becomes easier.

In the first embodiment, the external structure part 10 is formed of glass. It is difficult to provide the external structure part 10, which is formed of glass, with screw holes and locking claws for attachment. Therefore, the in-vehicle sensor installation structure that attaches the acoustic sensor device 100 using the adhesive layer 20 is particularly effective when the external structure part 10 is made of glass. In addition, glass has a lower density compared to iron and is also thinner, making it more permeable to sound. Therefore, according to the in-vehicle sensor installation structure that attaches the acoustic sensor device 100 to the glass, it is possible to sensitively detect sounds from outside the vehicle Ve. Additionally, the rear glass is relatively distant from the audio speakers. Therefore, by making the rear window Pb2 the external structure part 10, the acoustic sensor device 100 becomes less susceptible to audio noise.

Furthermore, in the first embodiment, the acoustic sensor device 100 includes multiple MEMS microphones 70. By having multiple MEMS microphones 70 in this manner, it becomes easier to secure the surface area of the attachment surface 31 of the sensor housing 30. As a result, even with an installation structure using the adhesive layer 20, it becomes possible to securely attach the acoustic sensor device 100 to the external structure part 10.

In addition, in the first embodiment, the multiple (two) MEMS microphones 70 are arranged side by side along the horizontal direction of the vehicle Ve. The detection signals output from each MEMS microphone 70 are input to the ECU 90. The ECU 90 performs signal processing based on the signal differences of the multiple detection signals. According to this signal processing, it becomes possible to estimate the direction of a sound source approaching the vehicle Ve.

In the first embodiment, the shielding wall 45 that separates the multiple MEMS microphones 70 is provided in the sensor housing 30. Therefore, each MEMS microphone 70 is located in an independent space. In other words, it becomes difficult for sounds (vibrations) to mix inside the sensor housing 30, allowing the MEMS microphones 70 to be acoustically isolated. As a result, the detection of the phase difference of sound using multiple MEMS microphones 70 can be reliably carried out.

Furthermore, in the first embodiment, a hollow soundproof space 46a that separates the multiple MEMS microphones 70 is provided in the shielding wall 45. According to the configuration in which the hollow soundproof space 46a is provided in the shielding wall 45, the acoustic isolation of each MEMS microphone 70 can be further ensured. As a result, the detection of the phase difference of sound using multiple MEMS microphones 70 can be carried out even more reliably.

In addition, in the first embodiment, since the sensor housing 30 is provided with a flat attachment surface 31, the acoustic sensor device 100 can be secured to the rear outer surface 11 of the external structure part 10 over a large area using double-sided tape or adhesive material. According to the above, the acoustic sensor device 100 can be easily and securely attached to external structure part 10 of various configurations. Therefore, it becomes possible to achieve an attachment suitable for the acoustic sensor device 100 that detects sound and vibration.

In the sensor housing 30 according to the first embodiment, a hollow sealed space 34 is defined between the attachment surface 31 and the exterior sound collection surface 71. By providing such the sealed space 34 and causing the air within the sealed space 34 to vibrate, the MEMS microphone 70 can effectively detect the sound (vibration) that reaches the external structure part 10 and is transmitted to the sensor housing 30.

In addition, in the first embodiment, the plate-shaped circuit board 80 housed in the sensor housing 30 cooperates with the sensor housing 30 to define the sealed space 34. That is, the interior side SN of the sealed space 34 is sealed by the circuit board 80. According to this configuration, it becomes possible to define the sealed space 34 inside the sensor housing 30 without complicating the structure of the sensor housing 30, thereby facilitating the assembly of the acoustic sensor device 100.

Additionally, in the first embodiment, the MEMS microphone 70 is mounted on the rear surface of the circuit board 80, which is the side opposite to the front surface facing the sealed space 34. Furthermore, in the portion of the circuit board 80 located between the exterior sound collection surface 71 and the sealed space 34, the sound hole 81 penetrating the circuit board 80 in the thickness direction is formed. With this configuration, vibrations in the sealed space 34 can be transmitted to the exterior sound collection surface 71 through the sound hole 81. Therefore, even when mounted on the rear surface of the circuit board 80, the MEMS microphone 70 can reliably detect the sound reaching the external structure part 10.

Furthermore, in the first embodiment, the soundproof filler 37 is disposed on the side opposite to the sealed space 34 with the circuit board 80 in between. The soundproof filler 37 is housed in the interior space 36 of the sensor housing 30, thereby blocking sound entering the sensor housing 30 from the rear cover 50 side and making it difficult for the sound to be transmitted to the MEMS microphone 70. Due to the soundproof effect of the soundproof filler 37, the MEMS microphone 70 can more reliably detect sounds from the exterior side of the vehicle Ve.

In addition, in the first embodiment, a recess 43 is formed in the attachment bottom wall 41 of the sensor housing 30. The recess 43 faces the sealed space 34 and reduces the wall thickness of the attachment bottom wall 41. Due to the reduction in wall thickness caused by the recess 43, sound that reaches the external structure part 10 is more easily transmitted to the sealed space 34. As a result, the MEMS microphone 70 is able to effectively detect sounds from the exterior side of the vehicle Ve. Furthermore, the strength of the attachment bottom wall 41 can be ensured at the portions where the recess 43 is not formed. Furthermore, since the recess 43 has a non-through structure, the sealing property of the sensor housing 30 can be maintained.

Additionally, in the first embodiment, the circuit board 80 is also provided with, for example, the amplifier circuit unit 85 and the communication interface 86. In this manner, by processing the detection signal within the acoustic sensor device 100, it is possible to improve noise resistance and enhance the signal-to-noise ratio (S/N ratio).

Furthermore, in the first embodiment, the peripheral wall 44 is formed thicker than the attachment bottom wall 41 and the rear cover 50. Therefore, sound and vibrations arriving from the side of the sensor housing 30 along the external structure part 10 can be effectively blocked by the peripheral wall 44.

Additionally, in the first embodiment, the multiple interior spaces 36 are interconnected via the space connection part 47. Therefore, it becomes possible to electrically connect the multiple circuit boards 80 via the board connection line 84 that passes through the space connection part 47.

In the first embodiment, the rear inner surface 12 corresponds to a “inner surface,” the sealed space 34 corresponds to the “hollow sound collection space,” the soundproof filler 37 corresponds to the “rear soundproof material,” the attachment bottom wall 41 corresponds to the “attachment wall” and the recess 43 corresponds to a “hole.” Additionally, the MEMS microphone 70 corresponds to the “sound detection sensor unit,” the exterior sound collection surface 71 further corresponds to the “sound collection surface,” the sound hole 81 corresponds to a “through-hole,” and the ECU 90 corresponds to a “signal processing unit.”

### Second Embodiment

An in-vehicle sensor installation structure according to a second embodiment of the present disclosure is applied to the external structure part 10 of the upper surface of the vehicle. The external structure part 10 has an upper outer surface 13 that is exposed to the outside of the vehicle Ve in an upward-facing posture toward the upper side Ue of the vehicle Ve. The external structure part 10 is, for example, the aforementioned roof panel and is formed of a sheet-like metal material (such as iron or aluminum). The in-vehicle sensor installation structure according to the second embodiment is applicable to all external surface components facing the upper side Ue of the vehicle Ve.

In the external structure part 10, the rear side of the upper outer surface 13 forms a smooth upper inner surface 14 to which the adhesive layer 20 is attached. The acoustic sensor device 100 is fixed to the external structure part 10 by having its attachment surface 31 held on the upper inner surface 14 by the adhesive layer 20.

### [Basic Configuration of the Acoustic Sensor Device]

As shown in FIGS. 8 to 10, the acoustic sensor device 100 of the second embodiment includes a piezoelectric sensor 270 as the sound detection sensor unit instead of the MEMS microphone 70 (see FIG. 2). Similar to the MEMS microphone 70, the piezoelectric sensor 270 forms an exterior sound collecting surface 71 and converts sound into electrical signals. The piezoelectric sensor 270 includes, for example, a piezoelectric element 270a and a metal plate 275.

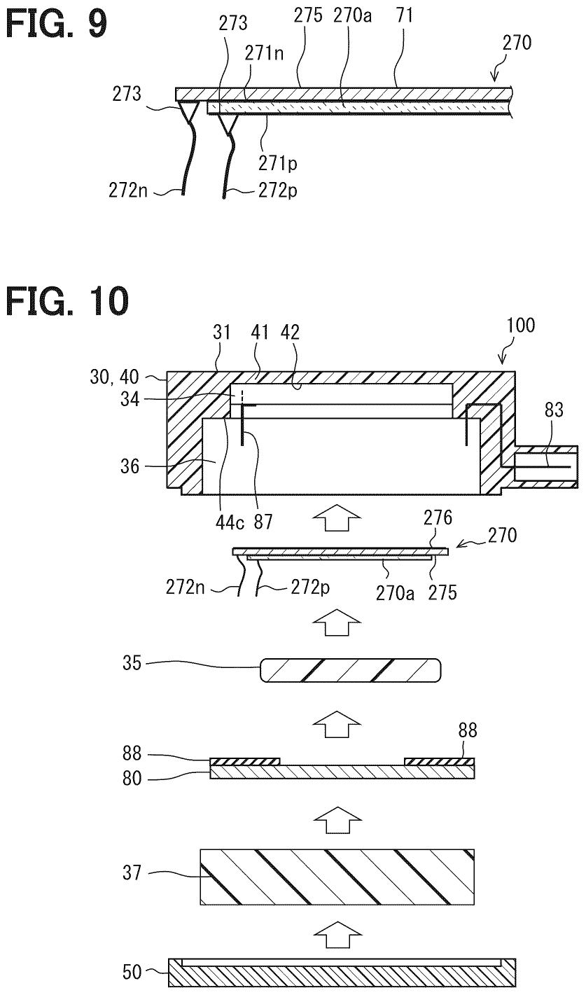

The piezoelectric element 270a is formed in a thin plate shape. A negative electrode 271n is formed on one surface (the front surface) of the piezoelectric element 270a. A positive electrode 271p is formed on the other surface (the back surface) of the piezoelectric element 270a. A positive wire 272p is connected to the positive electrode 271p by solder 273 (see FIG. 9). The piezoelectric element 270a generates a voltage between the negative electrode 271n and the positive electrode 271p in response to the applied stress.

The metal plate 275 is formed as a thin plate with a larger surface area than the piezoelectric element 270a. The metal plate 275 is joined to the surface on the negative electrode 271n side of the piezoelectric element 270a. A negative wire 272n is connected to the metal plate 275 by solder 273 (see FIG. 9). The metal plate 275 is electrically connected to the GND potential of the circuit board 80 via a negative wire 272n. The metal plate 275 vibrates integrally with the piezoelectric element 270a due to the sound transmitted to the sensor housing 30. In the metal plate 275, the front surface opposite to the piezoelectric element 270a serves as the exterior sound collecting surface 71 of the piezoelectric sensor 270. The piezoelectric sensor 270 is accommodated in the sealed space 34. The piezoelectric sensor 270 is held on the attachment bottom wall 41 of the sensor housing 30, which forms the attachment surface 31, by having the front surface of the metal plate 275 adhered to the inner bottom wall surface 42 with a piezo adhesive layer 276 (see FIG. 10). The piezo adhesive layer 276 is formed using double-sided tape or adhesive material. The negative electrode wire 272n and the positive electrode wire 272p of the piezoelectric sensor 270 are connected to one end of each of a pair of intermediate insert pins 87 by soldering, welding, crimping, or similar methods. The intermediate insert pins 87 are formed from a metallic material. The intermediate insert pins 87 are partially embedded in the housing body 40.

A vibration-damping filler 35 is disposed on the vehicle interior side SN of the piezoelectric sensor 270. The vibration-damping filler 35 is formed from materials such as urethane, silicone, or sponge, similar to the soundproof filler 37. By being positioned in the sealed space 34, the vibration-damping filler 35 functions to prevent unnecessary air expansion and contraction, suppress unwanted resonance, and cut high frequencies. In other words, the vibration-damping filler 35 attenuates the sound and vibration that have entered the sensor housing 30 from the vehicle interior side SN, preventing the observation of unwanted vibrations and resonance.

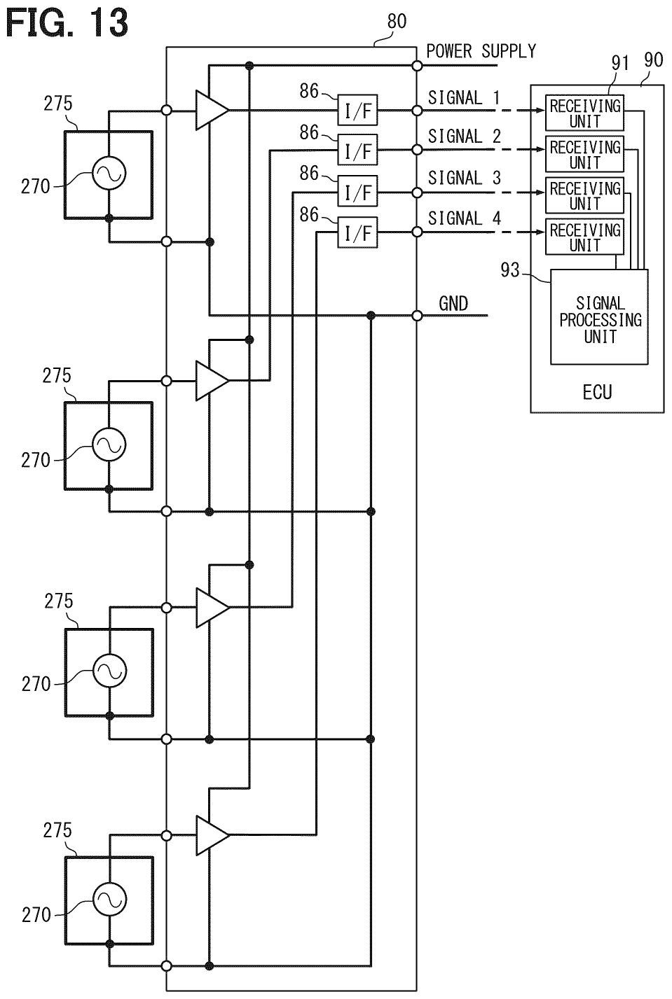

The circuit board 80 is held on a step portion 44c via the board fixing material 88, while compressing the vibration-damping filler 35 between the circuit board 80 and the piezoelectric sensor 270 (see FIG. 10). As the circuit board 80 is accommodated in the sensor housing 30, it is electrically connected to multiple intermediate insert pins 87 and connector insert pins 83. The intermediate insert pins 87 and connector insert pins 83 are electrically connected to the circuit board 80 by soldering, welding, or other similar methods. The piezoelectric sensor 270 is electrically connected to the amplifier circuit unit 85 on the circuit board 80 via the intermediate insert pins 87 (see FIG. 13). Furthermore, the detection signal from the piezoelectric sensor 270 can be output externally from the plug section connected to the connector part 38.

On the vehicle interior side SN of the circuit board 80, a soundproof filler 37 is arranged. The soundproof filler 37 is enclosed between the circuit board 80 and the rear cover 50 (see FIG. 10). The soundproof filler 37, along with the vibration-damping filler 35, suppresses vibrations from intruding into the sensor housing 30 from the vehicle interior side SN, preventing them from being transmitted to the piezoelectric sensor 270.

### [Acoustic Sensor Device of the Second Embodiment]

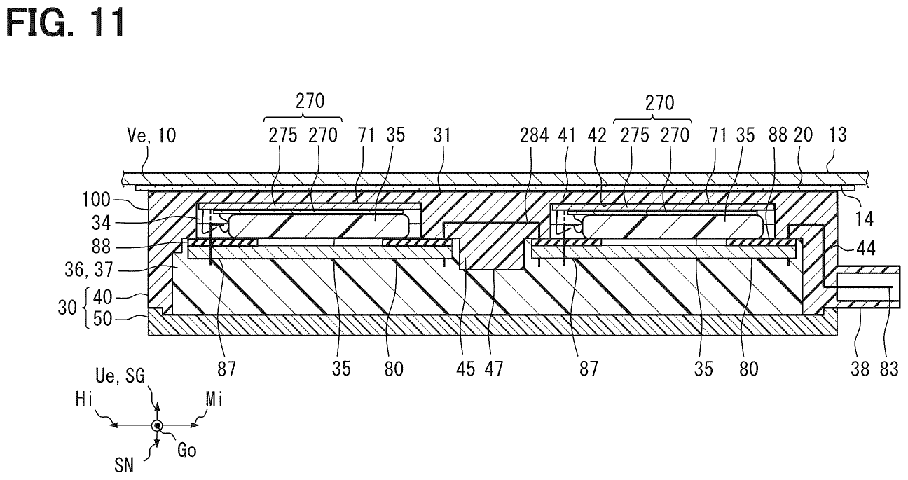

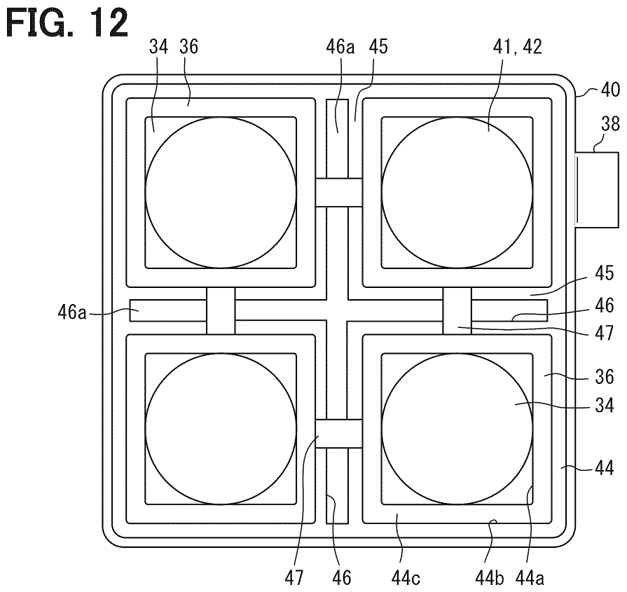

The acoustic sensor device 100 of the second embodiment shown in FIGS. 11 and 12 is configured by combining multiple (four) of the basic acoustic sensor devices 100 shown in FIG. 8. The acoustic sensor device 100 accommodates four piezoelectric sensors 270 and four circuit boards 80. When the acoustic sensor device 100 is mounted on an upper inner surface 14, the four piezoelectric sensors 270 are arranged in a horizontal alignment with their vehicle-exterior sound collection surfaces 71 oriented upward toward the upper side Ue of the vehicle Ve. In the second embodiment, each piezoelectric sensor 270 is arranged with a predetermined interval, with two sensors aligned along the lateral direction and two along the longitudinal direction of the vehicle Ve. By being installed on the roof panel, the acoustic sensor device 100 is capable of measuring sounds from the entire 360° surroundings of the vehicle Ve.

Among the four circuit boards 80, the one closest to the connector part 38 (hereinafter referred to as the output board) has connector insert pins 83 connected to it. On the other hand, the other three circuit boards 80 are electrically connected to the output board via board connection insert pins 284. With this configuration, the outputs of the four piezoelectric sensors 270 can be output through the connector insert pins 83 exposed at the connector part 38.

The output board and the other circuit boards 80 may also be electrically connected via board connection lines 84 (see FIG. 4). Furthermore, multiple connector parts 38 for outputting the detection signals from the piezoelectric sensors 270 may be provided in the sensor housing 30.

Inside the sensor housing 30, there are four separate sealed spaces 34 and four vehicle-interior spaces 36 that are interconnected by space connection parts 47 (see FIG. 12). Vibration-damping filler 35 is placed on the vehicle-interior side SN of each piezoelectric sensor 270 housed in the respective sealed spaces 34. Furthermore, each vehicle-interior space 36 and space connection part 47 is filled with foam urethane, foam silicone, or similar materials, forming an integral soundproof filler 37.

The sensor housing 30 is provided with a shielding wall 45 and a shielding groove 46, similar to the first embodiment. The shielding wall 45 separates the four sealed spaces 34. The shielding wall 45 extends in a cruciform shape to separate the four piezoelectric sensors 270 and the sealed spaces 34. The shielding groove 46 is formed in a cruciform shape along the shielding wall 45, partitioning a hollow soundproof space 46a within the shielding wall 45 (see FIG. 12). The formation of the shielding wall 45 and the soundproof space 46a ensures that the multiple sealed spaces 34 and the piezoelectric sensors 270 are acoustically isolated. The shielding groove 46 may be filled with a soundproof filler. Since each interior space 36 and the shielding groove 46 are connected by the space connection part 47, they can be filled with a soundproof filler in a single filling operation.

### [Electrical Configuration of Acoustic Sensor Device]

As shown in FIG. 13, each circuit board 80 of the acoustic sensor device 100 is provided with the aforementioned amplifier circuit unit 85 and communication interface 86. The amplifier circuit unit 85 and communication interface 86 are each provided for each piezoelectric sensor 270. Each communication interface 86 individually outputs the detection signal of each piezoelectric sensor 270 to the ECU 90.

The ECU 90 has four signal receiving units 91 and one signal processing unit 93. Each signal processing unit 91 receives detection signals (see signals 1 to 4 in FIG. 13) output from multiple piezoelectric sensors 270. Each signal receiving 91 provides the signal processing unit 93 with the signal obtained by performing a Fourier transform on each detection signal.

The signal processing unit 93 is pre-registered with information indicating the positional relationship of each piezoelectric sensor 270 in the front-rear and left-right directions. The signal processing unit 93 can estimate the arrival direction of the sound (vibration) detected by the piezoelectric sensors 270, in other words, the direction of the sound source as seen from the vehicle Ve, based on the signal differences of the four detection signals acquired from each signal processing unit 91, specifically the phase differences, time differences, and sound pressure differences.

### Summary of the Second Embodiment

In the second embodiment described so far, the acoustic sensor device 100 is attached to the external structure part 10 by having the flat attachment surface 31 provided on the sensor housing 30 held on the upper inner surface 14 by the thin adhesive layer 20. Therefore, the acoustic sensor device 100 can be easily and reliably attached to the external structure part 10 of various configurations. Thus, it becomes possible to achieve an attachment that is suitable for the acoustic sensor device 100, which detects sound and vibrations.

Specifically, since the acoustic sensor device 100 is attached to the external structure part 10 by the adhesive layer 20, there is no need to modify the structure of the vehicle's upper surfaces, such as the roof panel. Therefore, while keeping the installation cost of the acoustic sensor device 100 low, it becomes possible to detect sound and vibrations arriving from all directions over a 360° range with a single acoustic sensor device 100. In addition, the acoustic sensor device 100 can be mounted on the vehicle Ve without being subject to design constraints. Furthermore, since there is no structure protruding upward from the roof panel, the generation of wind noise can be suppressed. Additionally, because the external structure part 10 is oriented upward, snow accumulation on the upper outer surface 13 during driving is less likely to occur compared to the front outer surface.

Additionally, in the second embodiment, the exterior sound collection surface 71 that detects sound is formed by a piezoelectric sensor 270. The piezoelectric sensor 270 includes a monomorph vibrating plate formed by bonding a metal plate 275 with a piezoelectric element 270a. By using such a piezoelectric sensor 270, the sensitivity of sound detection can be improved. Furthermore, the metal plate 275 and the piezoelectric element 270a exhibit less characteristic variation due to temperature changes compared to resin materials. Therefore, using the piezoelectric sensor 270 enables the stable output of detection signals.

In the second embodiment, the intermediate insert pin 87, which is partially embedded in the sensor housing 30, electrically connects the piezoelectric sensor 270 to the circuit board 80. Thus, according to the configuration in which the intermediate insert pin 87, held in the sensor housing 30 by embedding, is interposed between the piezoelectric sensor 270 and the circuit board 80, the process of electrically connecting the piezoelectric sensor 270 and the circuit board 80 becomes easier.

Furthermore, in the second embodiment, the acoustic sensor device 100 is provided with multiple (three or more) piezoelectric sensors 270 arranged in the horizontal direction of the vehicle Ve, along both the longitudinal and lateral directions of the vehicle Ve. Therefore, by comparing the detection signals from each piezoelectric sensor 270, it becomes possible to estimate the direction of arrival of the sound (vibration) from the full 360° surroundings of the vehicle Ve. In addition, according to the configuration that obtains detection signals from multiple piezoelectric sensors 270, it is possible to improve the reliability and sensitivity of the detection results.

In addition, in the second embodiment, the piezoelectric sensor 270 is connected via the negative electrode wire 272n and the positive electrode wire 272p. If the piezoelectric sensor 270 is firmly connected to the circuit board 80, it may lead to a decrease in sensitivity or the reception of unnecessary vibrations. On the other hand, if the piezoelectric sensor 270 is electrically connected via flexible wires, the decrease in sensitivity and the reception of unnecessary vibrations are less likely to occur.

In the second embodiment, multiple interior spaces 36 are interconnected via the space connection part 47. Therefore, it becomes possible to fill each interior space 36 collectively with a soundproof filling material such as urethane foam.

Furthermore, in the second embodiment, the piezoelectric sensor 270 is joined to the inner bottom wall surface 42. With this arrangement, the piezoelectric sensor 270 can efficiently measure the sound transmitted to the external structure part 10 and the attachment bottom wall 41.

In the second embodiment, the upper inner surface 14 further corresponds to the “inner surface,” the intermediate insert pin 87 corresponds to the “connection part,” and the piezoelectric sensor 270 corresponds to the “sound detection sensor part” or “sound detection sensor unit.”

### Third Embodiment

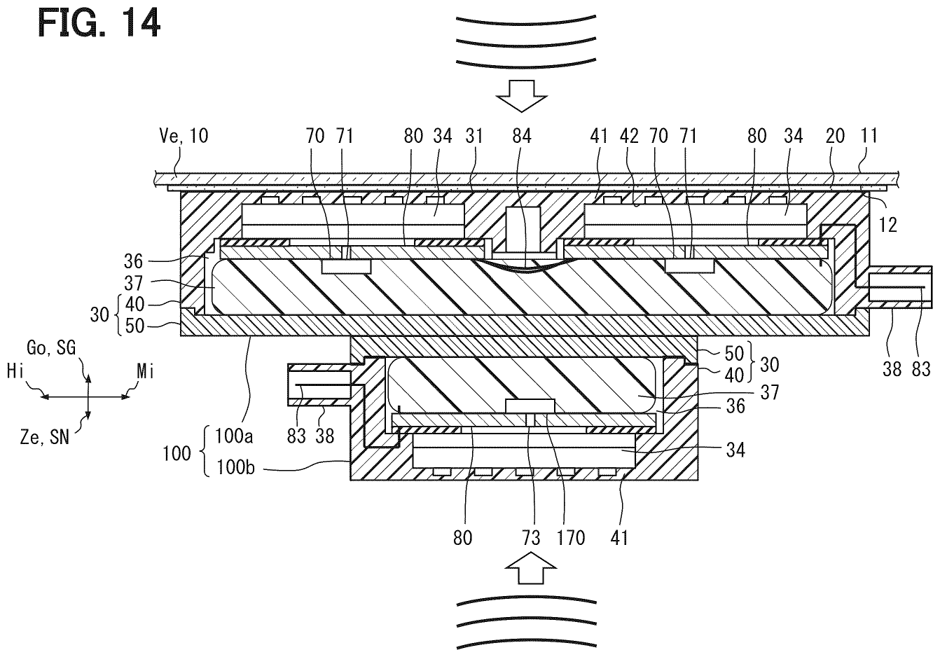

A third embodiment of the present disclosure shown in FIG. 14 is a modification of the first embodiment. In the vehicle-mounted sensor installation structure of the third embodiment, the acoustic sensor device 100 includes an external vehicle acoustic sensor device 100a and an internal vehicle acoustic sensor device 100b. The external vehicle acoustic sensor device 100a has a configuration substantially identical to the acoustic sensor device 100 installed on the rear inner surface 12 in the first embodiment and includes two MEMS microphones 70 with external sound collection surfaces 71.

The internal vehicle acoustic sensor device 100b has a configuration substantially identical to the basic configuration of the acoustic sensor device 100 described in the first embodiment. The internal vehicle acoustic sensor device 100b is held in an orientation facing the direction opposite to the external vehicle acoustic sensor device 100a. The internal vehicle acoustic sensor device 100b is arranged in the direction perpendicular to the external structure part 10 (hereinafter referred to as the inner-outer direction), so that it is aligned with the external vehicle acoustic sensor device 100a, and is positioned on the interior side SN relative to the external vehicle acoustic sensor device 100a.

The internal vehicle acoustic sensor device 100b is equipped with a single MEMS microphone 170. The MEMS microphone 170 is held on the rear side of the circuit board 80 with its sound collection surface (hereinafter referred to as the interior sound collection surface 73) oriented towards the interior side SN. The interior sound collection surface 73 detects sounds coming from inside the vehicle Ve (interior).

The ECU 90 (see FIG. 7) is equipped with three signal receiving units 91 and one signal processing unit 93. Each signal receiving unit 91 acquires two detection signals detected by the exterior sound collection surfaces 71 and one detection signal detected by the interior sound collection surface 73, and provides them to the signal processing unit 93. The signal processing unit 93 estimates the cabin noise received by the exterior sound collection surfaces 71 based on the interior sound measured by the interior sound collection surface 73 and the pre-measured transfer function. The signal processing unit 93 cancels out the cabin noise included in the exterior sound by subtracting the cabin noise from the detection signals of the exterior sound collection surfaces 71.

In the third embodiment described so far, the same effects as those of the first embodiment are achieved, making it possible to suitably install the acoustic sensor device 100 for detecting sound and vibration. Additionally, the acoustic sensor device 100 of the third embodiment includes not only the exterior sound collection surfaces 71 that detect sounds arriving from outside the vehicle Ve, but also the interior sound collection surfaces 73 that detect sounds arriving from inside the vehicle Ve. According to this configuration, it becomes possible to cancel out cabin noise. As a result, the influence of interior sounds on the sound detection by the exterior sound collection surfaces 71 can be suppressed.

In the third embodiment, the MEMS microphone 70 of the exterior acoustic sensor device 100a corresponds to a “first sound detection sensor unit,” and the MEMS microphone 170 of the interior acoustic sensor device 100b corresponds to a “second sound detection sensor unit.”

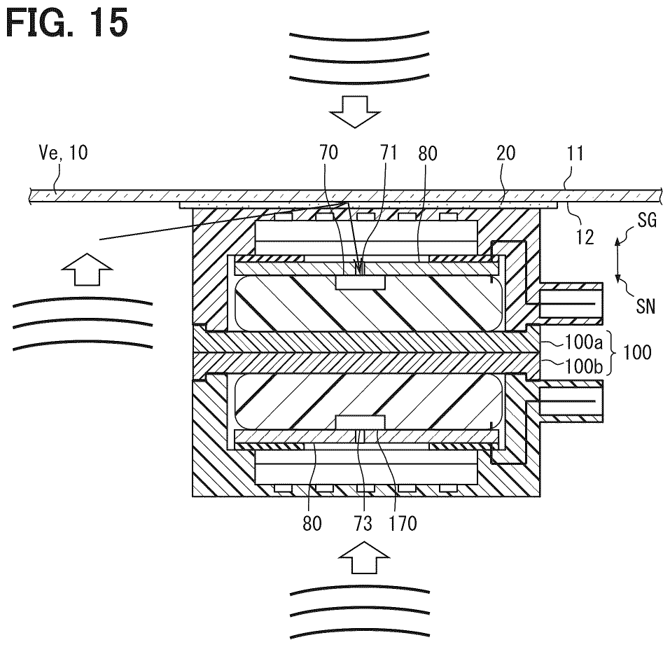

Additionally, as shown in the modified example of the third embodiment in FIG. 15, the exterior acoustic sensor device 100a may be configured to include only a single MEMS microphone 70, similar to the interior acoustic sensor device 100b. Even with such a configuration, a process to cancel out the interior sound from the exterior sound measured by the MEMS microphone 70 can be performed using the detection signal of the interior sound collected by the MEMS microphone 170.

### Fourth Embodiment

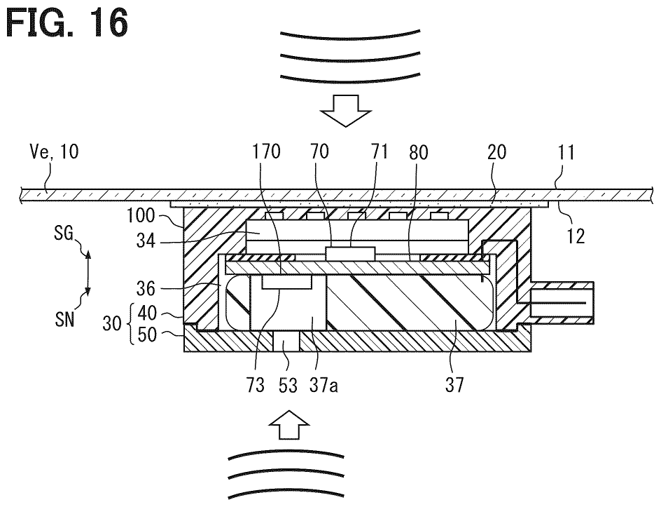

The fourth embodiment of the present disclosure shown in FIG. 16 is a modification of the third embodiment. In the acoustic sensor device 100 of the fourth embodiment, both the MEMS microphone 70 with an exterior sound collection surface 71 and the MEMS microphone 170 with an interior sound collection surface 73 are housed within a single sensor housing 30. The MEMS microphone 70 is mounted on the front surface of the circuit board 80 and is housed within the sealed space 34.

The MEMS microphone 170 is mounted on the rear surface of the circuit board 80 and is housed within the interior space 36. The soundproof filler 37 is formed with a microphone housing hole 37a to accommodate the MEMS microphone 170. The rear cover 50 is formed with a sound-collecting opening 53 to allow interior sounds to pass through. The MEMS microphone 170 detects interior sounds at the interior sound collection surface 73, which have passed through the sound-collecting opening 53 and the microphone housing hole 37a.

In the fourth embodiment described thus far, the same effects as those of the third embodiment are achieved, making it possible to cancel out cabin noise. As a result, the influence of interior sounds on the sound detection of the exterior sound collection surface 71 can be suppressed.

### Fifth Embodiment

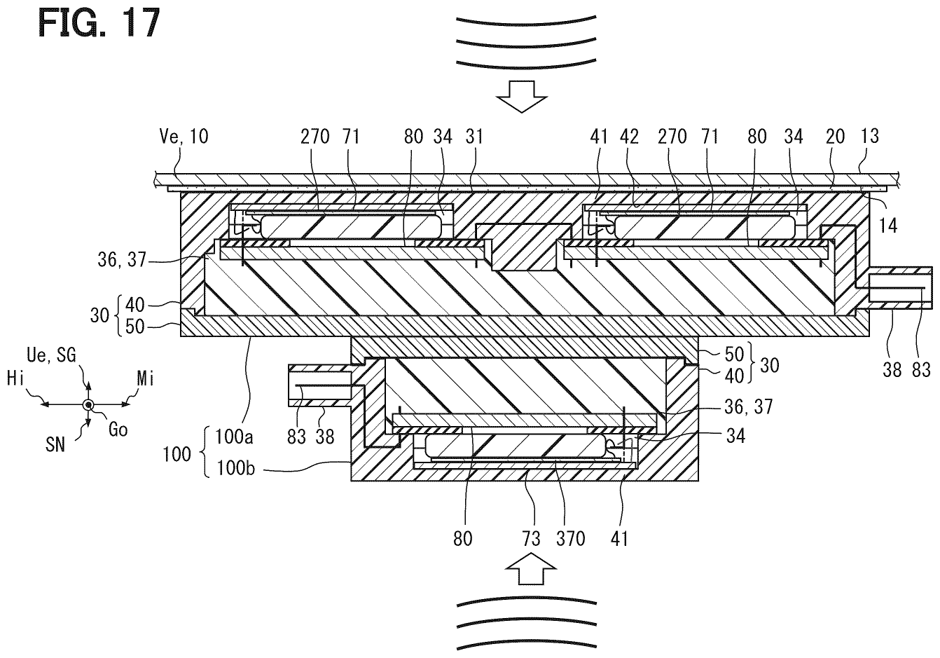

The fifth embodiment of the present disclosure shown in FIG. 17 is a modification of the second embodiment. In the vehicle-mounted sensor installation structure of the fifth embodiment, similar to the third embodiment, the acoustic sensor device 100, which includes the external acoustic sensor device 100a and the internal acoustic sensor device 100b, is mounted on the external structure part 10 of the vehicle Ve. The external acoustic sensor device 100a has substantially the same configuration as the acoustic sensor device 100 installed on the rear inner surface 12 in the second embodiment, and is equipped with two piezoelectric sensors 270 that form the exterior sound collection surface 71.

The internal acoustic sensor device 100b has substantially the same configuration as the basic configuration of the acoustic sensor device 100 described in the second embodiment. The internal acoustic sensor device 100b is held in an orientation opposite to that of the external acoustic sensor device 100a. In the internal acoustic sensor device 100b, the internal sound collection surface 73 is formed by the piezoelectric sensor 370.

Even in the fifth embodiment described thus far, the same effects as those of the third embodiment are achieved, making it possible to cancel out interior cabin noise. As a result, the influence of interior sounds on the sound detection of the external sound collection surface 71 can be suppressed. In the fifth embodiment, the piezoelectric sensor 270 of the external acoustic sensor device 100a corresponds to the “first sound detection sensor unit,” and the piezoelectric sensor 370 of the internal acoustic sensor device 100b corresponds to the “second sound detection sensor unit.” Additionally, in the third and fourth embodiments, one of the two MEMS microphones 70 may be used as the piezoelectric sensor 270. Furthermore, in the fifth embodiment, one of the two piezoelectric sensors 270 may be replaced with the MEMS microphone 70.

### Sixth Embodiment

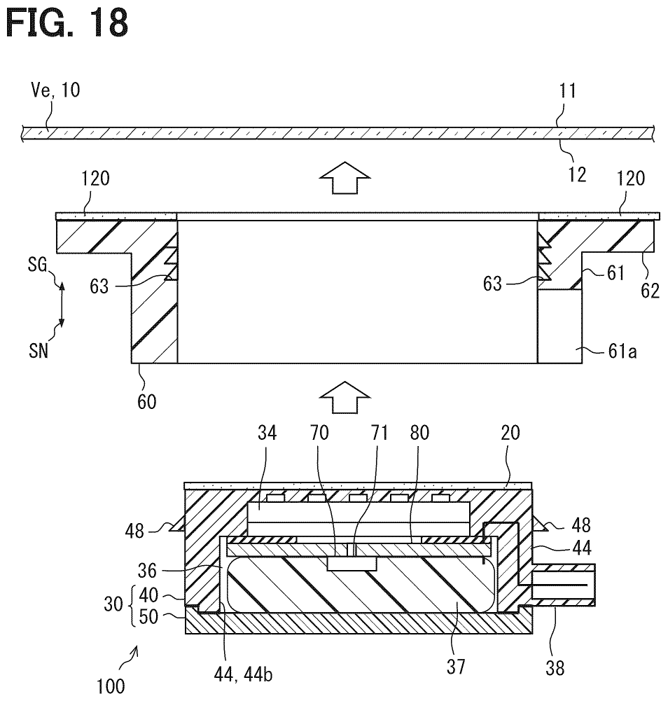

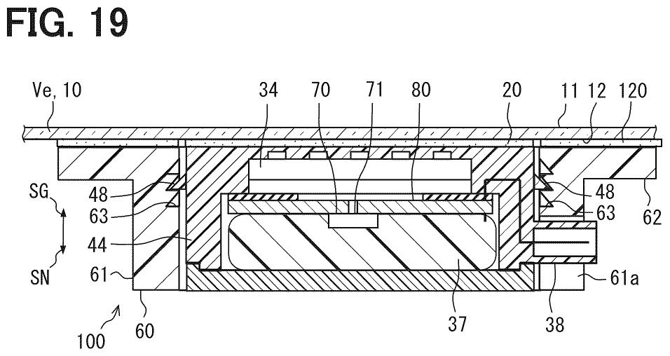

The sixth embodiment of the present disclosure shown in FIGS. 18 and 19 is yet another modification of the first embodiment. In the in-vehicle sensor installation structure of the sixth embodiment, the acoustic sensor device 100 further includes a retaining member 60.

The retaining member 60 is formed in an axially flattened tubular shape using a resin material. The retaining member 60 is held on the rear inner surface 12 (or the upper inner surface 14) of the external structure part 10 by an adhesive layer 120. The adhesive layer 120 is formed using double-sided tape or adhesive material, similar to the adhesive layer 20.

The retaining member 60 is provided with a surrounding wall 61 that encloses the sensor housing 30 and a securing portion 62 that is secured against the external structure part 10. The surrounding wall 61 is formed thicker than the peripheral wall 44 of the housing body 40. The surrounding wall 61 is formed with a notch 61a and an engagement groove 63. The notch 61a is a recessed portion provided in the surrounding wall 61 to avoid the connector part 38 that protrudes to the outer peripheral side of the housing body 40. The engagement groove 63 is a recessed groove formed from the inner peripheral wall surface of the surrounding wall 61. The engagement groove 63 engages with a claw portion 48 formed on the housing body 40. The securing portion 62 is a flange-like part that protrudes outward from the surrounding wall 61. The outer end surface SG of the securing portion 62 is secured against the rear inner surface 12 and the like via the adhesive layer 120.

The retaining member 60 is attached to the external structure part 10 prior to the sensor housing 30. The sensor housing 30 is inserted into the surrounding wall 61 of the retaining member 60, which is attached to the external structure part 10, and is held in place by the adhesive layer 20. Furthermore, the claw portion 48 provided on the outer peripheral wall surface of the peripheral wall 44 fits into the engagement groove 63, thereby allowing the sensor housing 30 to also be retained by the retaining member 60.

Even in the sixth embodiment described so far, similar effects to those of the first embodiment are achieved, enabling suitable mounting for the acoustic sensor device 100 that detects sound and vibration. Specifically, in the sixth embodiment, the acoustic sensor device 100 further includes the retaining member 60. The retaining member 60 is provided with the securing portion 62 that is retained by the external structure part 10. Therefore, the acoustic sensor device 100 can be more securely fixed to the external structure part 10.

In addition, the retaining member 60 is provided with a surrounding wall 61 that is shaped to encircle the sensor housing 30. Therefore, the sound and vibrations coming from the side of the sensor housing 30 can be more effectively blocked by the surrounding wall 61.

Furthermore, the retaining member 60 is attached to the external structure part 10 prior to the sensor housing 30. Therefore, it becomes possible to further achieve improvements in the positioning accuracy of the acoustic sensor device 100, enhancement of attachment strength, stabilization of the adhesive layer 20 thickness, and prevention of air bubble inclusion in the adhesive layer 20.

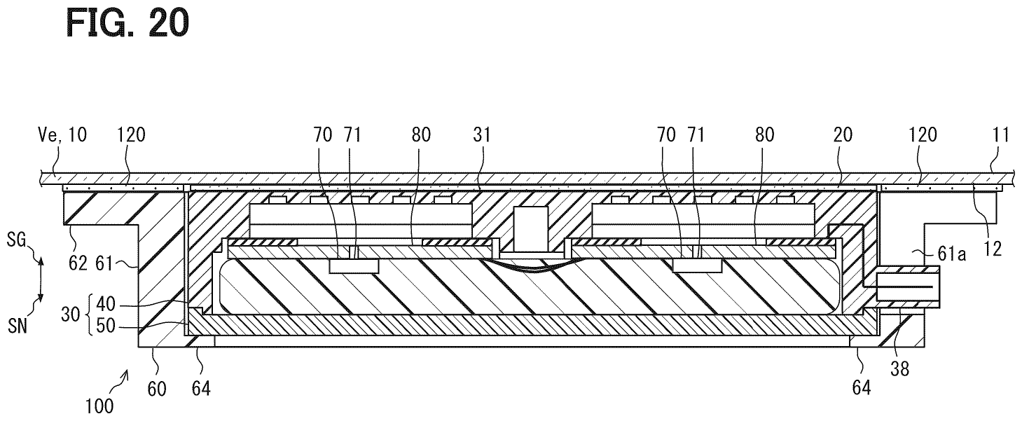

Furthermore, as in the modification of the sixth embodiment shown in FIG. 20, the acoustic sensor device 100 may be configured to include two MEMS microphones 70. Additionally, the retaining member 60 may be configured to be attached to the external structure part 10 after the sensor housing 30 is mounted. In such a configuration, the retaining member 60 is provided with a pressing protrusion 64. The pressing protrusion 64 is formed at the end of the surrounding wall 61 on the vehicle interior side SN. The pressing protrusion 64 presses the sensor housing 30 toward the external structure part 10 as the securing portion 62 is attached to the external structure part 10 via the adhesive layer 120.

### Seventh Embodiment

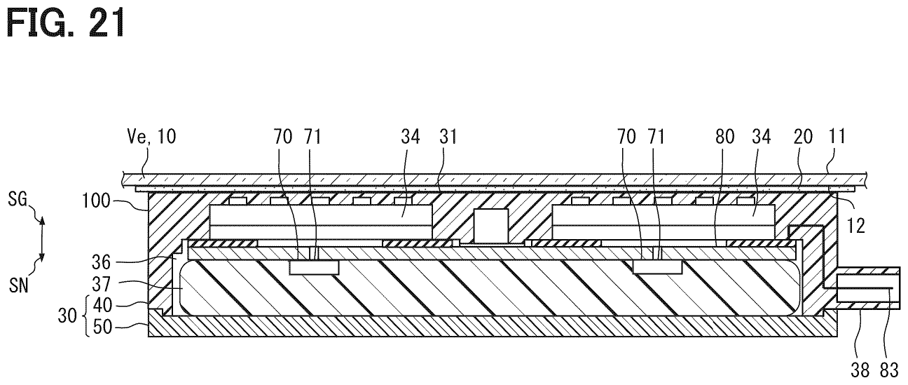

A seventh embodiment of the present disclosure shown in FIG. 21 is yet another modification of the first embodiment. In the acoustic sensor device 100 according to the seventh embodiment, multiple MEMS microphones 70 are mounted on a single circuit board 80. The circuit board 80 is provided with the same number of amplifier circuit units 85 (see FIG. 7) and communication interfaces 86 (see FIG. 7) as the number of mounted MEMS microphones 70. The circuit board 80 is placed in the interior space 36 that is integrally formed with the sensor housing 30 so as to seal multiple sealed spaces 34 from the interior side SN.

By connecting the circuit board 80 to which the MEMS microphones 70 are connected into a single unit as in the seventh embodiment, the configuration of the acoustic sensor device 100 can be simplified. As a result, it becomes possible to achieve cost reduction in the vehicle sensor installation structure. The circuit board 80 connected to the piezoelectric sensor 270 (see FIG. 11) may also be configured as a single connected unit.

### Eighth Embodiment

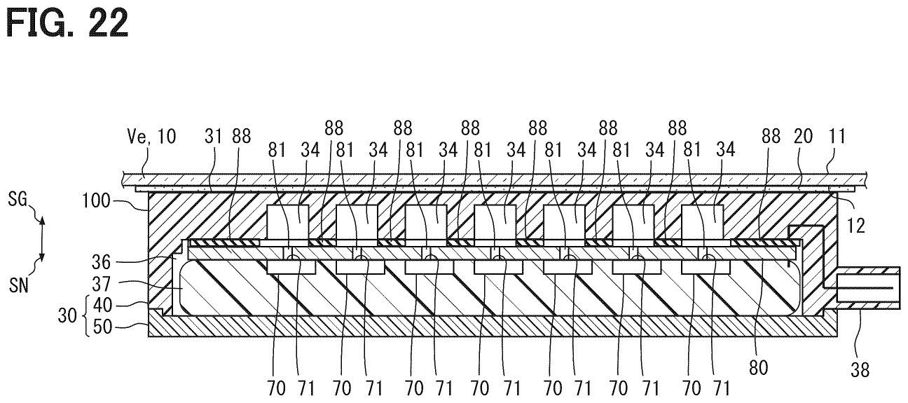

The eighth embodiment of the present disclosure shown in FIG. 22 is a modification of the seventh embodiment. In the acoustic sensor device 100 according to the eighth embodiment, a large number of MEMS microphones 70 are mounted at close intervals on a single circuit board 80. The numerous MEMS microphones 70 may be arranged in a single row, or they may be arranged in a two-dimensional array. Additionally, the piezoelectric sensor 270 may be placed on the sound collecting surface of the enclosed space instead of the MEMS microphones 70. Furthermore, both the MEMS microphones 70 and the piezoelectric sensors 270 may be arranged together. For example, the MEMS microphones 70 may be arranged in the odd-numbered rows of a two-dimensional array, while the piezoelectric sensors 270 may be arranged in the even-numbered rows.

The sealed spaces 34 corresponding to the arrangement of the MEMS microphones 70 is formed in the main housing body 40 of the housing. Similar to the first embodiment, the sealed spaces 34 are sealed by the circuit board 80 and the board fixing material 88, and are acoustically independent from each other. In the circuit board 80, multiple sound holes 81 are formed at the portions that serve as the exterior side SG of each exterior sound collecting surface 71, and these sound holes are continuous with the respective sealed spaces 34. According to the configuration of this eighth embodiment, the direction of the sound source can be estimated with higher accuracy.

### Ninth Embodiment

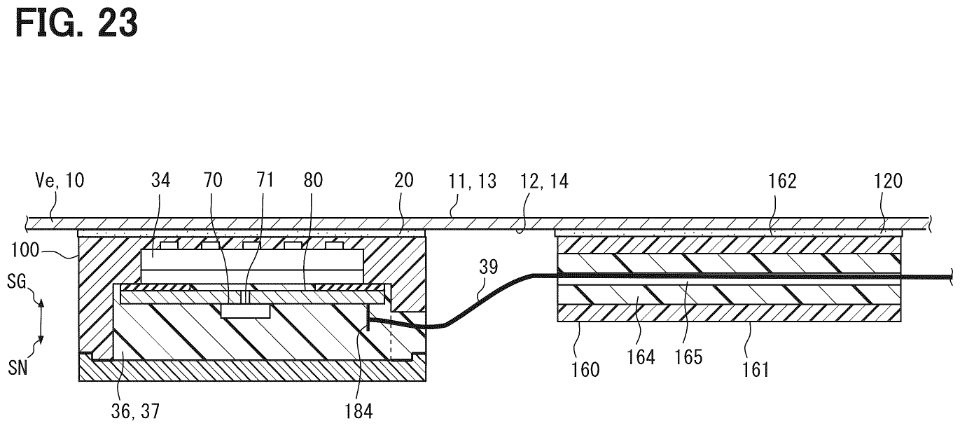

The ninth embodiment of the present disclosure shown in FIG. 23 is yet another modification of the first embodiment. In the ninth embodiment, the connector part 38 (see FIG. 2) is omitted. The detection signal of the MEMS microphone 70 is output to the ECU 90 (see FIG. 7) or the like via the output pin 184 provided on the circuit board 80 and a wire harness 39. The wire harness 39 is electrically connected to the output pin 184 by soldering, crimping, or the like. In addition to the output pin 184 and wire harness 39 that output the detection signal, there may also be output pins 184 and wire harnesses 39 that are connected to the power supply line of the circuit board 80 and provide power supply.

The in-vehicle sensor installation structure according to the ninth embodiment further includes a clamp member 160. The clamp member 160 is formed in a cylindrical shape from a resin material. The clamp member 160 is positioned in the vicinity of the acoustic sensor device 100 and is held together with the acoustic sensor device 100 by the external structure part 10. The clamp member 160 is affixed to the rear inner surface 12 or the upper inner surface 14 by the adhesive layer 120.

The clamp member 160 has a cylindrical clamp wall 161. A flat clamp attachment surface 162 is provided on the outer peripheral surface of the clamp wall 161. The clamp attachment surface 162 is held on the rear inner surface 12 or the upper inner surface 14 via the adhesive layer 120. The adhesive layer 120, similar to the adhesive layer 20, is formed using double-sided tape or an adhesive material. A damping material 164 is arranged on the inner peripheral side of the clamp wall 161.

The damping material 164 is formed in a columnar shape using materials such as sponge. The damping material 164 is in close contact with the inner peripheral side of the clamp wall 161. The damping material 164 is provided with a harness hole 165. The harness hole 165 is an elongated through-hole that extends axially through the damping material 164. The harness hole 165 accommodates the wire harness 39 for power supply and signal transmission.

The clamp member 160 secures the wire harness 39 to the external structure part 10. The portion where the clamp member 160 and the wire harness 39 come into contact is made of the damping material 164. The damping material 164 provides sound-absorbing and vibration-damping effects for the wire harness 39. Therefore, the transmission of vehicle vibrations and the like from the wire harness 39 to the circuit board 80, which could be detected by the MEMS microphone 70, can be suppressed.

### Tenth Embodiment

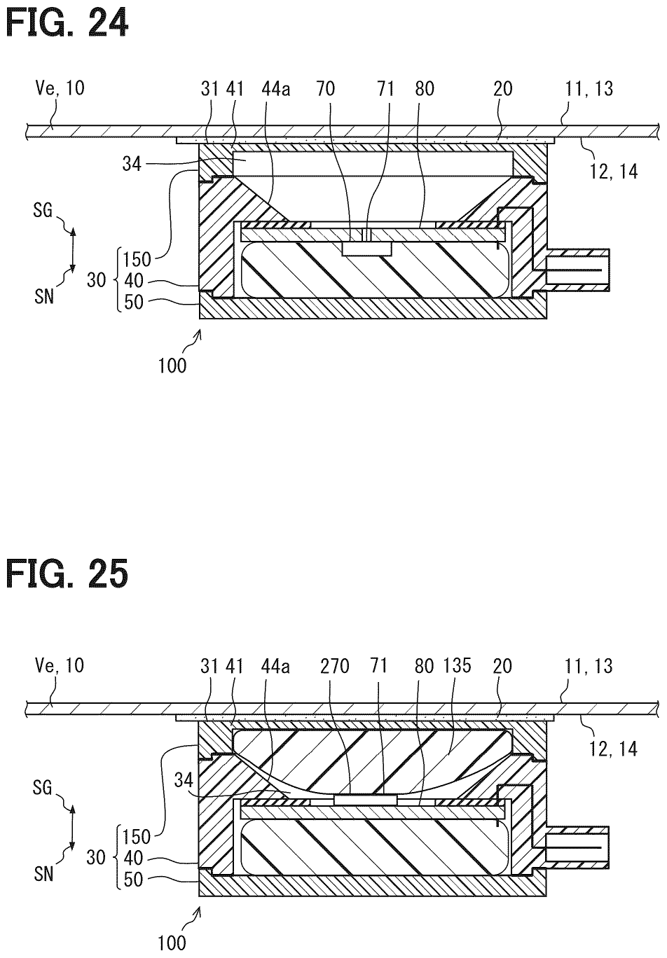

The tenth embodiment of the present disclosure shown in FIG. 24 is another modification of the first embodiment. In the acoustic sensor device 100 of the tenth embodiment, the sensor housing 30 includes a front cover 150 in addition to the housing body 40 and the rear cover 50. The front cover 150 is assembled to the end face of the vehicle-exterior side SG of the housing body 40 by adhesive or welding. The front cover 150 is provided with a attachment bottom wall 41 and an attachment surface 31. The front cover 150, together with the housing body 40 and the circuit board 80, defines a sealed space 34.

The housing body 40 has a tapered upper peripheral wall portion 44a. The upper peripheral wall portion 44a reduces the cross-sectional area of the sealed space 34 as it extends from the attachment surface 31 toward the vehicle-exterior sound collection surface 71. Due to the shape of the upper peripheral wall portion 44a, the sealed space 34 presents a partially conical or partially pyramidal shape.

In the tenth embodiment described thus far, the tapered upper peripheral wall portion 44a forms a horn structure inside the sensor housing 30. Therefore, it becomes possible to direct the directivity of sound detection outward. As a result, external sounds can be collected more effectively in the sealed space 34, potentially improving the sensitivity of the MEMS microphone 70. In the tenth embodiment, the upper peripheral wall portion 44a corresponds to a “peripheral wall portion.”

Furthermore, in the acoustic sensor device 100 according to a modified example of the tenth embodiment shown in FIG. 25, a piezoelectric sensor 270 is mounted on the front surface of the circuit board 80 instead of the MEMS microphone 70 (see FIG. 24). In addition, the sealed space 34 houses an acoustic matching material 135 formed in a partially conical or partially pyramidal shape. The acoustic matching material 135 can transmit sound or vibrations conveyed to the attachment bottom wall 41 to the external sound collection surface 71 more efficiently than through air. Therefore, in the eleventh embodiment as well, effective sound collection in the sealed space 34 becomes possible, potentially improving the sensitivity of the piezoelectric sensor 270.

### Eleventh Embodiment

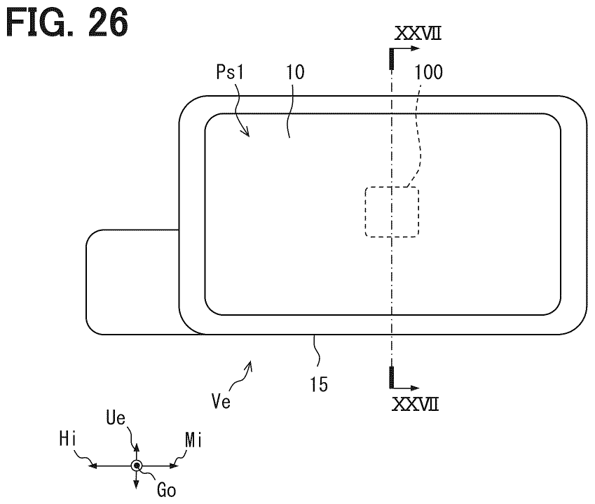

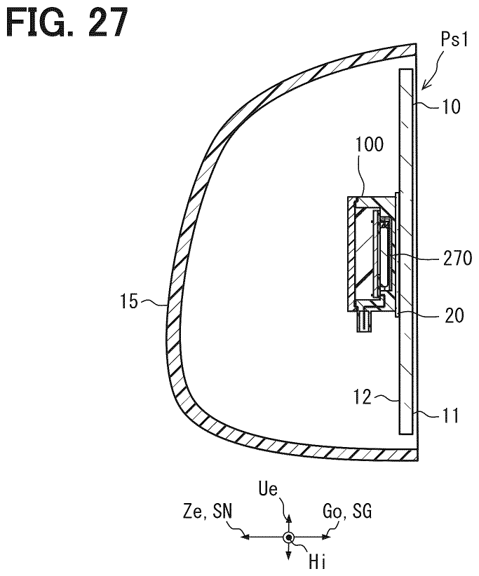

The eleventh embodiment of the present disclosure shown in FIGS. 26 and 27 is yet another modification of the first embodiment. The vehicle sensor installation structure of the eleventh embodiment is provided in the side mirror Ps1 of the vehicle Ve. The acoustic sensor device 100 is housed in a housing 15 of the side mirror Ps1. The acoustic sensor device 100 uses the mirror member of the side mirror Ps1 as the external structure part 10 and is mounted on the rear surface (rear inner surface 12) of this mirror member.

In the eleventh embodiment, by using a hard glass mirror member as the external structure part 10, the mirror member functions as an antenna that receives sound from the rear Go. As a result, the sensitivity of the piezoelectric sensor 270 (or MEMS microphone 70, see FIG. 2) is improved. Therefore, the vehicle sensor installation structure that uses the mirror member as the external structure part 10 provides a suitable mounting structure for the acoustic sensor device 100, which detects sound and vibration.

### OTHER EMBODIMENTS

As described above, multiple embodiments of the present disclosure have been explained. However, the present disclosure should not be interpreted as being limited to the above embodiments. Various embodiments and combinations thereof can be applied without departing from the scope and spirit of the present disclosure.

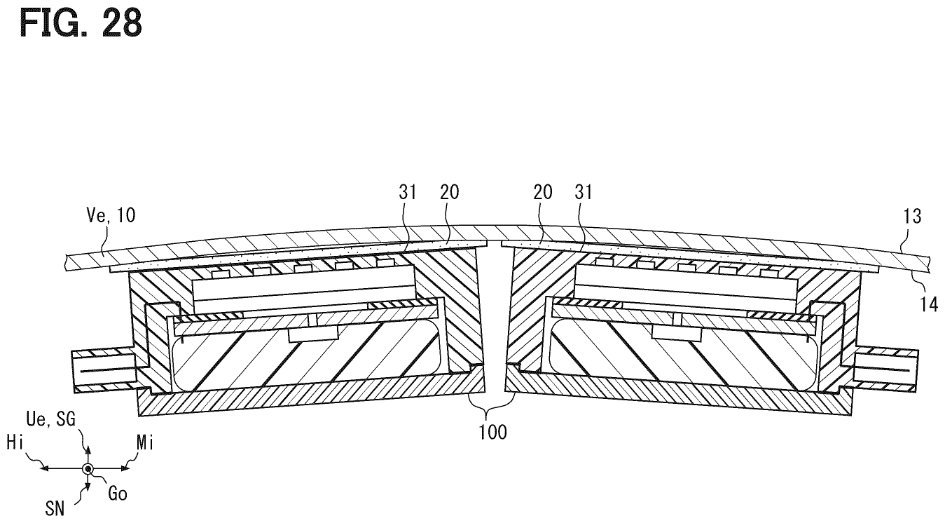

In Modification Example 1 of the second embodiment shown in FIG. 28, for drainage purposes, the roof panel of the vehicle Ve, which serves as the external structure part 10, is curved in a shape that is convex upward (toward the exterior side SG). In the vehicle sensor installation structure of Modification 1, two acoustic sensor devices 100, which have the basic configuration of the first embodiment, are arranged side by side in the lateral direction. The attachment surfaces 31 of each acoustic sensor device 100 are affixed to the upper inner surface 14 in an inclined posture relative to the horizontal direction, conforming to the curvature of the external structure part 10. At least a part of the gap that occurs between the flat attachment surface 31 and the curved upper inner surface 14 is filled by the deformation of the adhesive layer 20. According to Modification Example 1 described above, it is possible to securely install the acoustic sensor device 100 on the curved external structure part 10 without requiring any special processing.

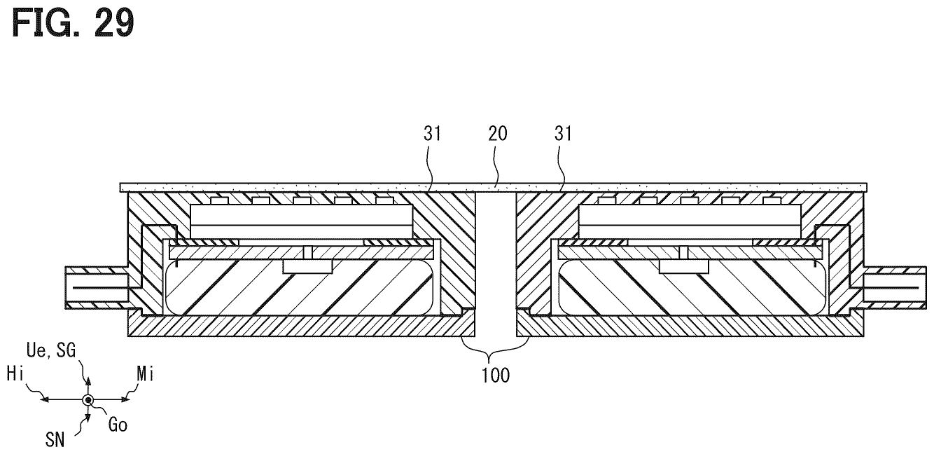

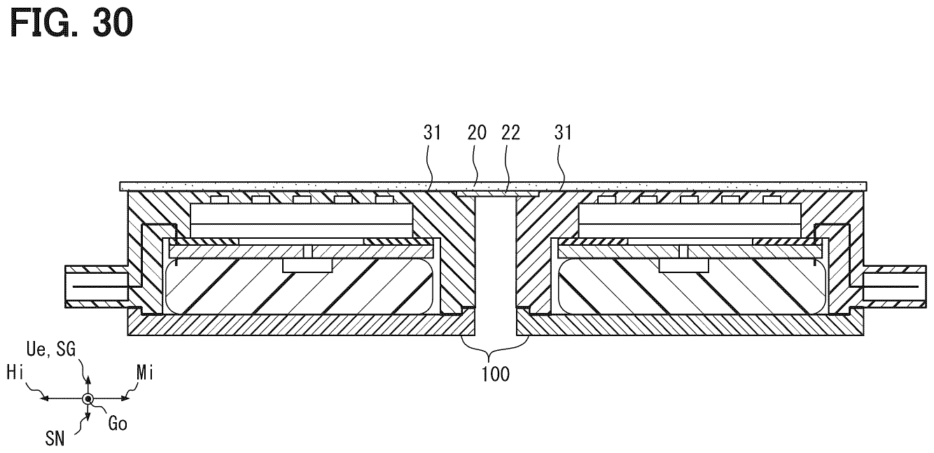

Furthermore, in the vehicle sensor installation structure of Modification 2 shown in FIG. 29, the two acoustic sensor devices 100 are connected by the single adhesive layer 20, such as double-sided tape. Additionally, in the vehicle sensor installation structure of Modification Example 3 shown in FIG. 30, the two acoustic sensor devices 100 are connected by a single adhesive layer 20 and a flexible connecting member 22. In the vehicle sensor installation structures of Modifications 2 and 3, the adhesive layer 20 and the connecting member 22 can bend between the two acoustic sensor devices 100, allowing each attachment surface 31 to conform to the curved external structure part 10 (see FIG. 28).

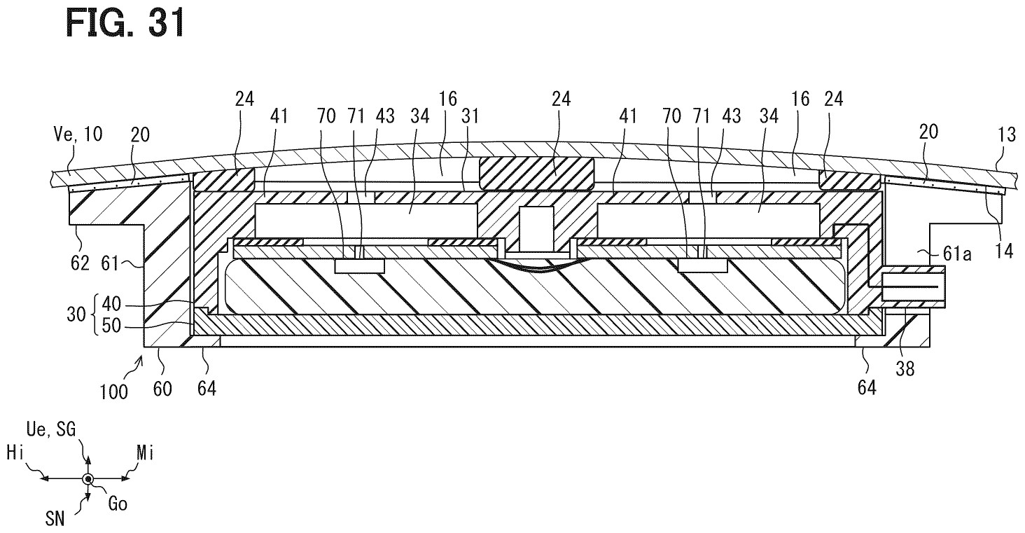

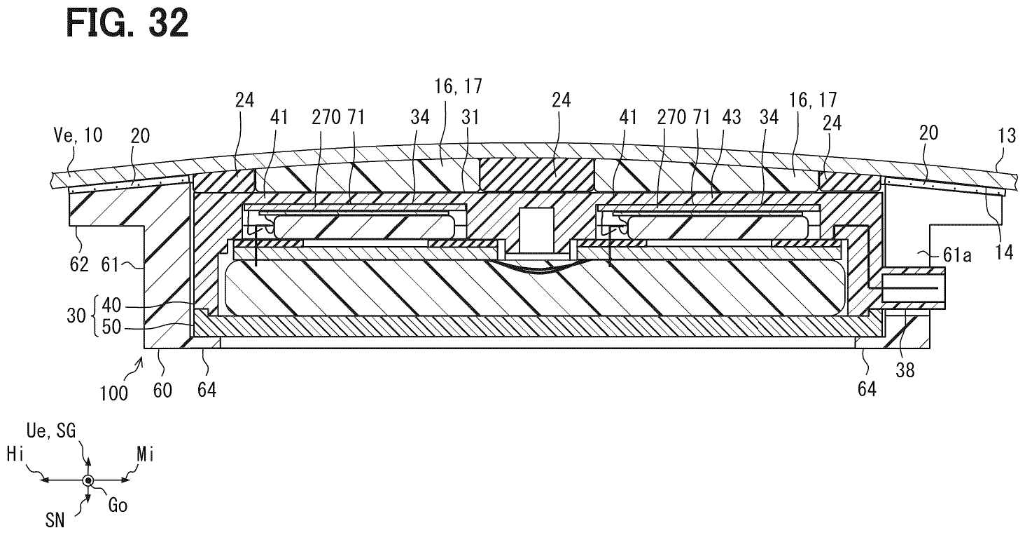

In the vehicle sensor installation structures of Modification Examples 4 and 5 shown in FIGS. 31 and 32, the sensor housing 30 is fixed to the curved external structure part 10 via the retaining member 60. The retaining member 60 is affixed to the upper inner surface 14 by the adhesive layer 20. The rear space 16 formed between the attachment bottom wall 41 and the upper inner surface 14 is partitioned into multiple sections and sealed by a sealing member 24. The sealing member 24 is made of rubber, foam material, or similar materials. The sealing member 24 prevents the intrusion of water and other substances into the rear space 16.

The acoustic sensor device 100 of Modification Example 4, shown in FIG. 31, includes the MEMS microphones 70. The recess 43 formed in the attachment bottom wall 41 of the sensor housing 30 penetrates through the attachment bottom wall 41 in the thickness direction. The recess 43 functions as a sound hole that connects the sealed space 34 with the rear space 16. The sound hole formed by the recess 43 may be provided with a membrane or the like that allows the transmission of sound but does not allow the passage of air or moisture.

The acoustic sensor device 100 of Modification Example 5, shown in FIG. 32, includes the piezoelectric sensors 270. The recess 43 (see FIG. 31) is not provided in the attachment bottom wall 41 to which the piezoelectric sensors 270 are attached. An acoustic matching material 17 is accommodated in the rear space 16 defined between the attachment bottom wall 41 and the rear inner surface 12. The acoustic matching material 17 can transmit the sound or vibration conveyed to the external structure part 10 to the attachment bottom wall 41 more efficiently than through air. In the rear space 16, an adhesive or other material may be filled instead of the acoustic matching material 17.

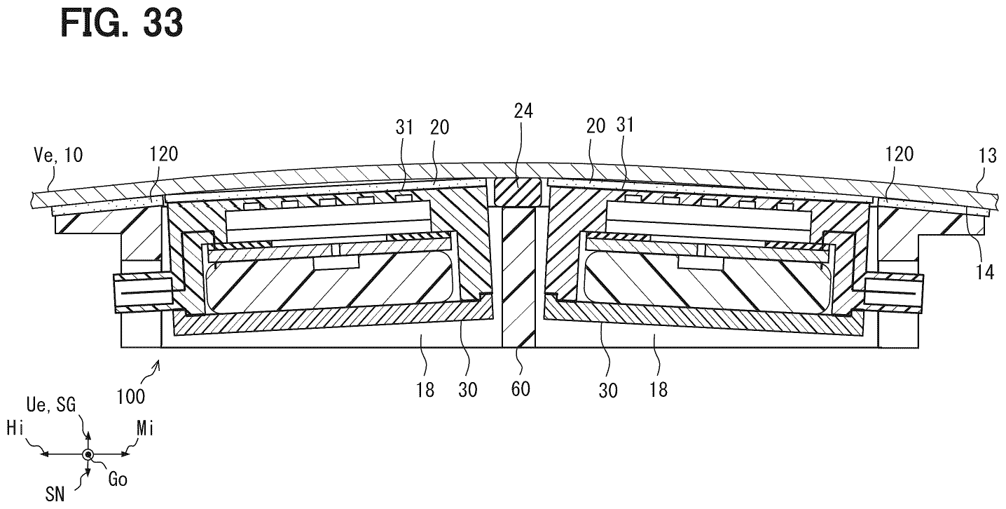

In the Modification Example 6 of the vehicle-mounted sensor installation structure shown in FIG. 33, multiple sensor housings 30 are fixed to the curved external structure part 10 via a retaining member 60. The retaining member 60 is affixed to the upper inner surface 14 by the adhesive layer 120. Each sensor housing 30 is inserted into a fixing hole 18, which is partitioned by the retaining member 60 and the sealing member 24, and is held to the upper inner surface 14 inside the fixing hole 18 via the adhesive layer 20.

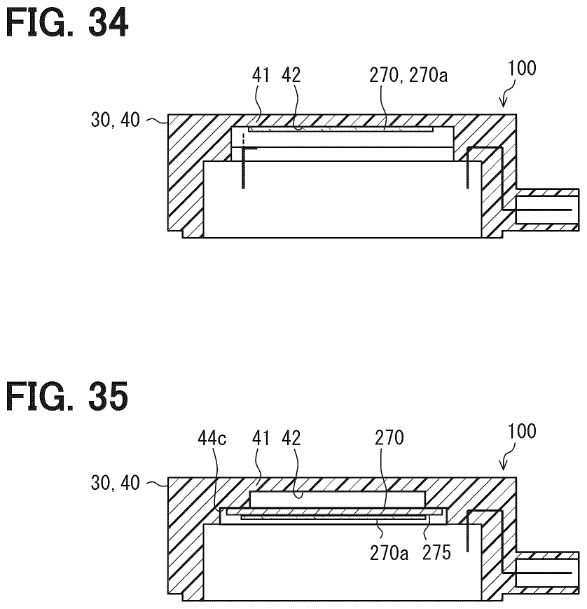

In Modification Example 7 of the second embodiment shown in FIG. 34, the configuration of the piezoelectric sensor 270 has been changed. In the piezoelectric sensor 270 of Modification Example 7, the metal plate 275 (see FIG. 9) is omitted. The piezoelectric element 270a of the piezoelectric sensor 270 is housed in the sealed space 34 and is affixed to the inner bottom wall surface 42 of the attachment bottom wall 41 using double-sided tape or the like.

In Modification Example 8 shown in FIG. 35, the piezoelectric sensor 270, which includes a monomorph diaphragm having the piezoelectric element 270a and the metal plate 275, is affixed to the stepped portion 44c at a position spaced apart from the attachment bottom wall 41 using an adhesive member such as double-sided tape.

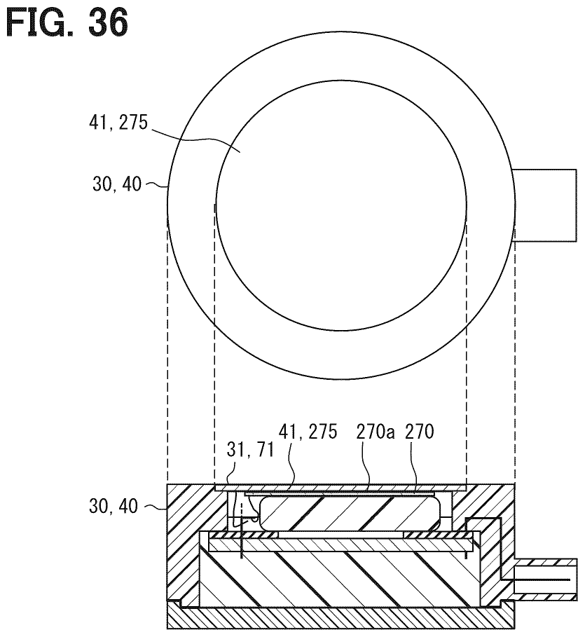

Furthermore, in Modification Example 9 shown in FIG. 36, the metal plate 275 of the piezoelectric sensor 270 forms the attachment bottom wall 41. The metal plate 275 covers the opening provided in the housing body 40, and the metal plate 275, the housing body 40, and other components are included in the sensor housing 30. The metal plate 275 is exposed from the sensor housing 30 and is directly affixed to the external structure part 10 via double-sided tape or a similar adhesive. In such Modification Example 9, sound is efficiently transmitted from the external structure part 10 to the exterior sound collection surface 71, thereby potentially improving the sensitivity of the piezoelectric sensor 270.

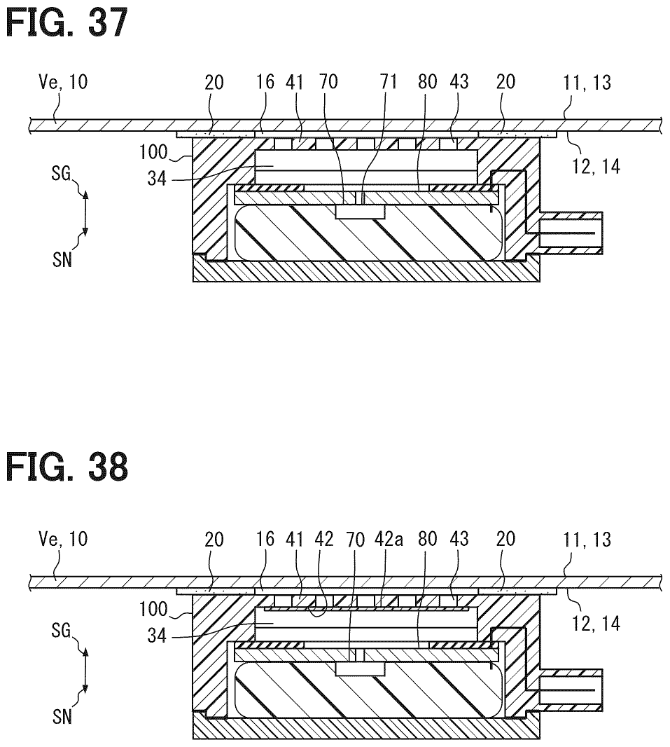

In Modification Example 10 shown in FIG. 37, the adhesive layer 20 is divided to create the rear space 16 between the attachment bottom wall 41 and the rear inner surface 12. The rear space 16 is sealed by the adhesive layer 20. The adhesive layer 20 can prevent the ingress of water or other substances into the rear space 16. Similar to Modification Example 4 (see FIG. 1), the recess 43 is a through-hole that penetrates the attachment bottom wall 41. The recess 43 connects the rear space 16 with the sealed space 34, functioning as a sound hole. Even in this Modification Example 10, it is possible to improve the sensitivity of the MEMS microphone 70. Alternatively, instead of the attachment bottom wall 41 provided with numerous sound holes, the attachment bottom wall 41 may be formed from a fibrous material that allows sound to pass through but not water. In other words, a fibrous material that combines waterproof and moisture-permeable properties (for example, GORE-TEX, registered trademark) may be used.

Additionally, as in Modification Example 11 shown in FIG. 38, a thin-film protective sheet 42a, which allows sound to pass through but not water or dust, and is made of materials such as fiber, rubber, or resin, may be affixed to the inner bottom wall surface 42. The protective sheet 42a covers the inside of the recess 43. According to this configuration, it becomes possible to prevent the intrusion of water, dust, and the like into the sealed space 34 before it is mounted to the external structure part 10.

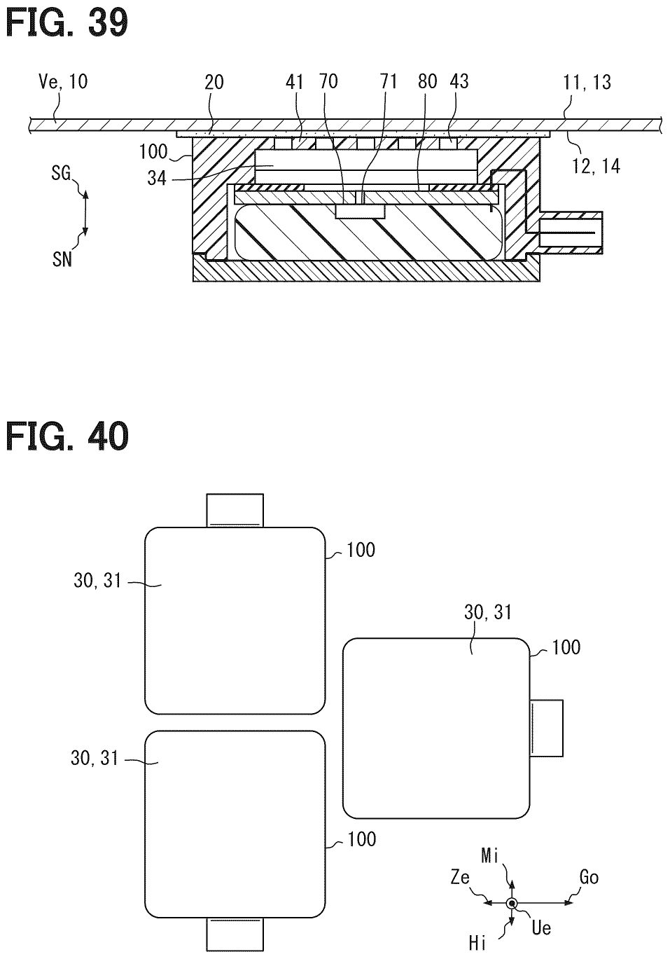

Furthermore, as in Modification Example 12 shown in FIG. 39, the outer side of the recess 43, which is a through-hole, may be sealed with the adhesive layer 20, such as double-sided tape.

Furthermore, in the in-vehicle sensor installation structure according to Modification Example 13 of the second embodiment shown in FIG. 40, three acoustic sensor devices 100 are arranged in the front, rear, left, and right directions. As in Modification Example 13, if three or more acoustic sensor devices 100 (sound detection sensor units) are positioned offset from each other in the front-rear and left-right directions, it becomes possible to estimate the direction of the sound source.

What is claimed is:

1. An in-vehicle sensor installation structure comprising:
an external structure part having a plate shape, the external structure part having
an outer surface exposed to an exterior of a vehicle, and
an inner surface positioned on a rear side of the outer surface; and
an acoustic sensor device including
a sensor housing secured against the inner surface, and
a sound detection sensor unit accommodated in the sensor housing, the sound detection sensor unit having an exterior sound collection surface that faces the external structure part and detects a sound from outside of the vehicle and a vibration within the external structure part.

2. The in-vehicle sensor installation structure according to claim 1, wherein
the sensor housing has an attachment surface, the in-vehicle sensor installation structure further comprising:
an adhesive layer in a form of a thin film that secures the attachment surface against the inner surface.

3. The in-vehicle sensor installation structure according to claim 2, wherein
the external structure part is made of glass.

4. An in-vehicle sensor installation structure comprising:
an external structure part having a plate shape, the external structure part having
an upper outer surface exposed to an exterior of a vehicle and facing top of the vehicle, and
an upper inner surface positioned on a rear side of the upper outer surface; and
an acoustic sensor device including
a sensor housing secured against the upper inner surface, and
a sound detection sensor unit accommodated in the sensor housing, the sound detection sensor unit having an exterior sound collection surface that faces the external structure part and detects a sound from outside of the vehicle and a vibration within the external structure part; and
an adhesive layer in a form of a thin film that secures the acoustic sensor device against the upper inner surface.

5. The in-vehicle sensor installation structure according to claim 4, wherein
the sensor housing has an attachment surface, and
the adhesive layer secures the attachment surface against the upper inner surface.

6. An in-vehicle sensor installation structure comprising:
an external structure part having a plate shape, the external structure part having
an upper outer surface exposed to an exterior of a vehicle and facing top of the vehicle, and
an upper inner surface positioned on a rear side of the upper outer surface; and
an acoustic sensor device including
a sensor housing secured against the upper inner surface, and
a sound detection sensor unit accommodated in the sensor housing, the sound detection sensor unit having an exterior sound collection surface that faces the external structure part and detects a sound from outside of the vehicle and a vibration within the external structure part; and
a retaining member that secures the acoustic sensor device against the upper inner surface.

7. The in-vehicle sensor installation structure according to claim 1, wherein
the sound detection sensor unit is one of sound detection sensor units included in the acoustic sensor device.

8. The in-vehicle sensor installation structure according to claim 1, wherein
the sound detection sensor unit is one of sound detection sensor units that are included in the acoustic sensor device and aligned along a horizonal axis of the vehicle.

9. The in-vehicle sensor installation structure according to claim 7, wherein
the sound detection sensor units are configured to output detection signals to a signal processing unit, and
the signal processing unit is configured to execute signal processing based on a signal difference between the detection signals.

10. The in-vehicle sensor installation structure according to claim 7, wherein
the sensor housing has a shielding wall that separates the sound detection sensor units.

11. The in-vehicle sensor installation structure according to claim 10, wherein
the shielding wall has a soundproof space that is hollow or filled with sound-absorbing material to separate the sound detection sensor units.

12. The in-vehicle sensor installation structure according to claim 1, wherein
the sound detection sensor unit is a first sound detection sensor unit, and
the acoustic sensor device includes:
the first sound detection sensor unit; and
a second sound detection sensor unit has an interior sound collection surface that detects a sound from an interior of the vehicle.

13. The in-vehicle sensor installation structure according to claim 1, wherein
the acoustic sensor device further includes a retaining member having
a surrounding wall surrounding the sensor housing, and
a securing portion that is secured against the external structure part.

14. An acoustic sensor device secured against an external structure part of a vehicle, the external structure part having a plate shape, the acoustic sensor device comprising:
a sound detection sensor unit having a sound collection surface that detects a sound and a vibration within the external structure part; and
a sensor housing secured against an inner surface of the external structure part by an adhesive layer, the sensor housing accommodating the sound detection sensor unit such that the sound collection surface is along the inner surface.

15. The acoustic sensor device according to claim 14, wherein
the sensor housing has an attachment surface, and
the adhesive layer is in a form of a thin film and secures the attachment surface against the inner surface of the external structure part.

16. The acoustic sensor device according to claim 15, wherein
the sensor housing defines a hollow sound collection space between the attachment surface and the sound collection surface.

17. The acoustic sensor device according to claim 16, further comprising:
a circuit board on which the sound detection sensor unit mounts, the circuit board having a plate shape and accommodated in the sensor housing, wherein
the circuit board and the sensor housing define the hollow sound collection space.

18. The acoustic sensor device according to claim 17, wherein
the circuit board has a front surface and a rear surface that are opposed to each other,
the front surface faces the hollow sound collection space,
the sound detection sensor unit mounts on the rear surface of the circuit board, and
the circuit board has a through-hole that penetrates the circuit board in a thickness direction of the circuit board at a section between the sound collection surface and the hollow sound collection space.

19. The acoustic sensor device according to claim 17, further comprising:
a rear soundproof material that is accommodated in the sensor housing, wherein
the circuit board is between the hollow sound collection space and the rear soundproof material.

20. The acoustic sensor device according to claim 16, wherein
the sensor housing has a peripheral wall portion having a tapered shape that reduces a cross-sectional area of the hollow sound collection space from the attachment surface toward the sound collection surface.

21. The acoustic sensor device according to claim 16, wherein
the sensor housing includes an attachment wall having an attachment surface, and
the attachment wall has a hole portion that faces the hollow sound collection space and reduces a wall thickness of the attachment wall.

22. The acoustic sensor device according to claim 16, wherein
the sound detection sensor unit includes a piezoelectric element and is secured against an attachment wall of the sensor casing having the attachment surface.

23. The acoustic sensor device according to claim 22, further comprising:
a circuit board having a plate shape, the circuit board accommodated in the sensor housing, the circuit board and the sensor housing defining the hollow sound collection space; and
a connection part partially embedded in the sensor housing, the connection part electrically connecting the piezoelectric element to the circuit board.
